(19) United States
(12) Patent Application Publication
(10) Pub. No.: US 2010/0161459 A1
(43) Pub. Date: Jun. 24, 2010

(54) Systems and methods for acquiring, managing, placing, collecting and reselling debt

(75) Inventors: Stephen B. Kass, Bel Air, CA (US); Michael E. Bernstein, Palm Beach, FL (US); Kevin Davis, Delray Beach, FL (US)

Correspondence Address: ROTHWELL, FIGG, ERNST & MANBECK, P.C., 1425 K STREET, N.W., SUITE 800, WASHINGTON, DC, 20005, US

(73) Assignee: CreditMax LLC, West Palm Beach, FL (US)

(21) Appl. No.: 12/656,757

(22) Filed: Feb. 16, 2010

Related U.S. Application Data
(63) Continuation of application No. 11/506,207, filed on Aug. 18, 2006, now abandoned.
(60) Provisional application No. 60/709,099, filed on Aug. 18, 2005.
(60) Provisional application No. 60/776,915, filed on Feb. 28, 2006.

(51) Int. Cl. G06Q 40/00; G06Q 10/00; G06F 15/16

(52) U.S. Cl. 705/30; 705/35; 705/36 R; 705/37; 709/204

(57) ABSTRACT

A system is provided for comprehensive debt management. Debt is typically acquired in the form of portfolios from the issuers of debit (e.g., creditors, such as credit card banks), which are referenced herein as “primary issuers” of debt. The custodian of the present invention is the acquiring party and is referenced as the “secondary issuer” of debt. Such portfolios are normally expansive and may cover a very large geographically region, such as the state of Texas. The system can parse the debt and assign any portion thereof to collection agencies or even directly to individual collectors.

### CROSS-REFERENCE TO RELATED APPLICATIONS

This application claims priority to provisional application No. 60/709,099, filed on Aug. 18, 2005, and provision application No. 60/776,915, filed on Feb. 28, 2006, the entire contents of each of which are incorporated herein by reference.

### BACKGROUND OF THE INVENTION

1. Field of the Invention

The present invention relates generally to systems and methods for acquiring, placing, collecting and reselling all types of debt and the managing of those processes on a daily basis with an automated management system (AMS). In particular, the invention is directed to: (a) Systems and methods for purchasing all types of debt from issuers or other debt owners; (b) Managing all types of debt that have been acquired for collection or resale by any debt owner; (c) Placing all types of debt for collection electronically to collection agencies and/or directly with collectors; (d) Collecting all types of debt; and, (e) Selling or reselling all types of uncollected debt online.

2. Description of the Related Art

All types of debt have grown. Consumer debt, in particular, continues to grow exponentially on a global basis, with billions of dollars of consumer debt in the U.S. alone. What is alarming is the fact that the number of accounts that are considered “delinquent” for failure to make timely payments is also increasing at a rapid pace. In the U.S. alone, there are billions of dollars of consumer debt in delinquent accounts. While large issuers of consumer debt, such as CITIBANK, J.P. MORGAN CHASE and BANK OF AMERICA-MBNA, employ efforts to collect the debts that have fallen into delinquency, every year, tens of billions of dollars of debt, such as credit card debt, is “charged-off” by issuers costing the U.S. Government and American taxpayers billions of dollars of lost tax revenue. Under the current U.S. Federal regulations governing “charged-off” debt, such as credit card debt, an issuer must reserve one hundred (100%) percent for accounts that are six (6) months consecutively delinquent. Such debt is either (i) placed with collection agencies for collection (or collected by in house collectors) or (ii) sold by debt issuers in large portfolios (often in the hundreds of millions of dollars) to debt buyers who collect the debt or package the debt and resell it to another debt buyer (including those collection agencies that purchase debt), etc.

There are a relatively few number of issuers of debt relative to the number of buyers in the process. When an issuer sells debt, it generally sells all of its “charged off” debt accounts that it desires to sell at any given time, together in a large portfolio. For example, each month, major issuers of credit card debt like CITIBANK, charge off billions of dollars of debt as uncollectible. CITIBANK, just one such issuer, charges off approximately $500 million of unpaid principal balances (UPB) per month of its credit card accounts. Part or all of these charged off accounts will be packaged as a single, large portfolio of accounts for sale National in scope, or it will be cut into smaller portfolios and sold to a number of buyers. In either case, the dollar amounts of unpaid principal balance will be too large for the traditional and numerous “small” buyers. It is not practical for the issuers to sell individual or selected smaller amounts of debt to “small” buyers for a number of reasons, including: (a) many transactions require higher support and overhead expense for the seller (Issuer); (b) increasing the number of buyers requires additional staff for the Seller (Issuer) to repurchase accounts where the debtor was deceased prior to the sale or had filed for bankruptcy before the sale, etc.; (c) small buyers may desire a geographic or other debt characteristic requiring the Seller (Issuer) to sell other than a randomly generated mix of accounts leaving the balance of accounts to be sold as “Adversely selected” thereby diminishing their value. Lastly, contract issues and disclosure issues increase as the number of buyers increases. Consequently, creditors typically sell debt to national or large regional buyers. These large buyers will either seek to collect the debt through in-house collectors or by outsourcing the collections to a collection network comprised of collection agencies, or turn around and repackage the debt in smaller regions, such as in states or groups of states, for resale. Thus, under the conventional debt purchasing schemes, it is not possible to buy selected debt, such as specific accounts, from an Issuer or reseller.

Debt buyers typically assign or place some or a portion of their debt to in-house collectors for collection, and/or place some or all of the accounts with collection agencies. Typically, the debt buyer will pay the collectors or collection agency for their services at a rate of around 18-28% of their collections for Fresh debt (charged off within thirty (30) days and not previously placed for collection and 30% to 50% for debt six (6) month or older and previously placed for collection either in house or with an outside agency(ies). It is typical for a collection agency or individual collectors to focus their collection efforts on those accounts in the portfolio they believe will have the highest probability of collection, and to spend little or no time making efforts to collect on other debtor accounts. As a result, agencies and collectors may not even attempt to collect on a high percentage of debt in a portfolio that is placed with them. It is likely, therefore, that as much as Eighty (80%) percent of the collections come from as few as Twenty (20%) of the accounts leaving Eighty (80%) percent of the accounts either underperforming or with no collection effort.

The above problem is primarily the result of how the debt is placed with agencies and subsequently with the collectors. Debt purchasers after deciding what volume to place with an agency will typically place debt randomly selected to the agency or pseudo-randomly selected to agencies, possibly on nothing more than a ranking system for each agency based solely on the agency(ies) historical results thus creating a self fulfilling prophecy that future results will mirror historical results. When an agency receives a debt portfolio, it then divides the portfolio into portions and distributes (places) the portions to its collectors in a similarly random or pseudo-random fashion without much, if any, attempt to place the debt with collectors on a basis where the debt is placed by it's (the debt's) characteristics not the collectors characteristics and unique skills in collecting certain debt where historical results have demonstrated that the collector has generated considerably higher collection results (recoveries). For example, a collector who does not speak Spanish is equally likely to be given an account of a likely Spanish speaking debtor. This results in the collector not placing an equal effort at collecting the debt and leaving the debtor with an increased likelihood of a continuing poor credit rating as well as an unequal opportunity to enter into a mutually satisfactory payment plan. In another example, a collector who is born and raised in a particular city is more likely to personally relate to the collector and have a better understanding of the local community the debtor lives in thereby increasing the likelihood that a mutually beneficial payment arrangement may be determined.

In the conventional debt collection process, for example, the collection agency or collectors are basically focusing on the top 20% of the debt placed with them for collection based on, for example, the FICO scoring model. There is little or no focus on collecting the other 80% of the debt placed with them. Thus, there is a need for a system that elevates the status of the lower level accounts (i.e., the 80%) by placing it with a collection agency or individual collector that does better with those debt/debtor characteristics. The conventional scoring model used today scores debt (based, for example, on the characteristics of the debt, such as the amount of the debt, length of time of delinquency, the debtor's age, number of late payments, total debts, whether the debtor is a home owner, the debtor's FICO score) without regard for placing that debt with the collector who has the highest probability of collecting that debt. The debt scoring models do not consider or take into account, in any systematic or meaningful way, the characteristics of the collector and/or the collection agency and individual collectors of the agency are therefore not considered as a factor in placing the debt which is a critical drawback with such models. For example, a collection agency located in the same time zone as the account holders of the debt to be collected has a higher probability of collecting the debt because more time during the work day is afforded the collector to identify, contact and discuss with the debtor a payment or payment plan. Further, a collector that is a middle-aged female located in the Midwest may have a higher success rate in collecting debt that is between $1 to 2 thousand dollars, between 7-12 months delinquent, with a female debtor that is also middle-aged than that same collector might have with a debtor who owes $35,000 that is twelve months delinquent.

Thus, there is a need for systems and methods for placing debt that can optimize the placement process and, thereby, maximize the probability of collection, as well as managing the debt collection process on a micro basis affording the debt owner an opportunity to place the debt with another collector and/or agency while it is still early enough in the process to maximize the opportunity for collection, and the resale of debt. Most debt collection tracking/management systems do not provide the detail or any information on a real time or daily basis leaving the owner merely reviewing period results and using those results solely to determine where the next placement will go as opposed to how to increase collection results on the current (present) placement. This results in many unfortunate results: (a) the debt owner recovers less and therefore must rely on heavy handed tactics with those debtors who are willing to pay something depriving those debtors with an equal opportunity to settle their obligations on easier payment terms or for less money; (b) as the debt owner recovers less, they must reduce fees to agencies leaving the agencies no choice but to reduce compensation to the collectors leaving the collectors with reduced incomes and causing very high employee turnover (40-70% per year); (c) As agencies receive reduced fees from the debt owner (agency revenue) they in turn reduce collector compensation causing higher turn over and higher costs for the agency resulting in many agencies not being able to stay in business; (d) debtors are not able to settle their debt on an economically acceptable basis and end up with little opportunity to correct a poor credit rating which results in higher interest expense on loans like home mortgages causing a negative impact on the housing market and all manufacturers of consumer goods reducing profit in all sectors of the economy; (e) the U.S. government and U.S. taxpayer carries the burden of this industry dilemma.

### SUMMARY OF THE INVENTION

The present invention improves over the prior art by providing a method and system for managing debt assignment and collections, relations with the collection agencies, reclaiming uncollected debt, and reselling the reclaimed uncollected debt.

Embodiments of the invention provide: The present invention is an improvement over the prior art because it provides: (a) a method for placing all types of debt directly with collectors; (b) a system for managing the debt buying, placing for collection and the collection itself processes on, at a minimum, a daily basis; (c) a system for evaluating the collection agencies; (d) a system for recalling the uncollected debt from the collection agency(ies) after a predetermined collection period; and (e) a system for reselling the recalled uncollected debt to the buyer in whose hands the debt has its maximum economic value.

According to one aspect of the present invention, debt portfolios may be placed and/or any portion of a portfolio placed with collectors rather than collection agencies by a novel selection process. Debt portfolios are not placed in all or in part based solely upon: (a) Geographic consideration; (b) Traditional debt scores; (c) Random placement to an agency; or, (d) Placing debt directly with an agency(ies). Instead, debt is placed by a selection process which takes into account particular characteristics of each individual collector's unique personality characteristics and their performance history. Each collector is given a questionnaire containing 148 questions, although any number of statistically valid questions may be used. One such questionnaire has been developed by CreditMax™ based upon two years of collection results (the minimum time period determined necessary to generate statistically valid results) for each collector. This data has been correlated and has identified certain profiles for a collector that indicates that a collector will out perform other collectors on certain debt accounts. At this point a “Debt Collector Profile” is established. The “Debt Collector Profile” utilizes all historical account data from each debt account placed with that collector. The account data includes data on: (1) The debt (including data defined in Section 0009 (a), (b), and (c) immediately above; (2) Debtor; and, (3) Issuer of the debt. To determine the statistical validity of the results they are then compared with two years (could be more or less depending on factors used to define “Statistical Validity” and acceptable standard deviation) of actual collection results for each collector to confirm that the projected “best” accounts for each collector were, in fact, accounts on which the collector outperformed the norm. As a result, the present invention allows the debt owner to match debt with a collector based upon the collector's actual historical collection experience as the determinant in the collector's likelihood of collecting a new or future account. For example, if a collector who answered certain questions (or combinations of questions) with certain answers combined with the collector historical collection experience showing great success collecting payoffs from debtors, aged 37 to 42 years old, living in Illinois having CHASE BANK credit card debt of $7,500 to $10,000, then a new debt account with these characteristics will be selected from a purchased or issuer originated debt portfolio and assigned directly to that collector.

According to another aspect of the present invention, a system is provided for comprehensive debt management. The system has unique attributes of collecting individual account data (collection activity) and maintains that data in a data base where additional data is stored such as collector data and agency data through customized report writing capability, to generate virtually any results data from collector/account activity, on a real time (as data is input by collectors/agencies basis thus enabling management to see whether the collection activity is above, at or below expectation (Plan) and which collector/agency is contributing to such results. The placement model will actor in the performance of each collector and agency and determine based on logic how much debt will be placed with that collector and agency. For example, a better performing collector will likely receive a larger placement and a poor performing collector will receive a reduced placement or may be placed on probation and not receive the next placement until the current results have been improved. The system may be configured to maintain data relating to the acquisition and processing of debt, analysis of the debt, assignment of debt to collection agencies, receipt of payments from agencies, reclamation of uncollected debt from the agencies, and sale of the recalled debt. The system is preferably, but not essentially, a web-enabled electronic data processing system and is configured to provide access to online debt sales. The system may also be further configured to provide reporting and bench marking functions. The system may be outfitted with appropriate hardware and software, including, for example, client interfaces for input and output of data, reporting tools, databases, etc., which can effect the features described in this document, as well as any other well known or obvious related features not described herein.

According to another aspect of the present invention, a novel, comprehensive incentive and bonus program is provided that increases the efficiency of collection agencies and individual collectors over prior art agencies and collectors. Each collector is profiled—detailed information about each collector, which may be collected through surveys and the like. Such information can include a psychological profile, personal preferences and intimate information, such as a spousal profile. This information can be managed and used to tailor incentives and bonuses for each individual collector. Further, it has been determined that such a program coupled with a higher than average commission and the novel assignment process, achieve unprecedented results from participating collection agencies and collectors.

According to one aspect of the present invention, a system is provided for comprehensive debt management. The system may be configured to maintain data relating to the acquisition and processing of debt, analysis of the debt, assignment of debt to collection agencies, receipt of payments from agencies, reclamation of uncollected debt from the agencies, and sale of the recalled debt. The system is preferably a web-enabled electronic data processing system and may be configured further to provide access to online debt sales. The system may be further configured to provide reporting and bench marking functions. The system may be outfitted with appropriate hardware and software, including, for example, client interfaces for input and output of data, reporting tools, databases, etc., which can effect the features described in this document, as well as any other well known or obvious related features not described herein.

According to another aspect of the present invention, debt portfolios may be parsed and any portion of a portfolio assigned to collectors rather than collection agencies by a novel selection process. Debt portfolios are not assigned in their entirety or solely on region, and traditional debt scores are not solely relied upon. Instead, debt may be assigned to collection agencies by a selection process which takes into account particular characteristics of each individual collector's performance history. As a result, the present invention allows the present invention to perfectly match debt with a collector. For example, if a collector showed great success collecting payoffs from single women having credit card debt of less than $10,000, then debt for single women having credit card debt of less than $10,000 can be selected from a debt portfolio and assigned directly to that collector.

According to another aspect of the present invention, a novel, comprehensive incentive and bonus program is provided that increases the efficiency of collection agencies and individual collectors over prior art agencies and collectors. Each collector is profiled—detailed information about each collector, which may be collected through surveys and the like. Such information can include a psychological profile, personal preferences and intimate information, such as a spousal profile. This information can be managed and used to tailor incentives and bonuses for each individual collector. Further, it has been determined that such a program coupled with a higher than average commission and the novel assignment process, achieve unprecedented results from participating collection agencies and collectors.

According to another aspect of the present invention, debt is assigned to collectors rather than collection agencies in order to eliminate debt culling and cherry picking by the agencies.

According to another aspect of the present invention, uncollected debt may be automatically recalled from the assigned collection agencies after a predetermined period of time, such as 120 days.

According to another aspect of the present invention, recalled debt may be input into a novel debt sales system (DSS) for resale. The debt sales system is capable of selling debt at any level, such as individual debt or regional portfolios. The DSS includes a client interface that can be accessed over an electronic data network, such as the Internet, and preferably includes a search engine capable of allowing a prospective debt purchaser to identify, with particularity, debt portfolios or individual debt. One exemplary DSS is described in U.S. Provisional Application No. 60/709,099, which has already been incorporated herein, and in U.S. Ser. No. ______, entitled “Debt Sales System and Method,” filed on Aug. 17, 2006, the entire contents of which are hereby incorporated by reference.

Further applications and advantages of various embodiments of the present invention are discussed below with reference to the drawing figures.

### BRIEF DESCRIPTION OF THE DRAWINGS

FIG. 1A is block diagram of a comprehensive debt management system according to an embodiment of the present invention.

FIG. 1B is a flow chart of a method for purchasing debt from issuers, managing debt that has been acquired or is in the collection or resale process, placing debt with collectors electronically for collection, collecting debt, and for reselling uncollected debt online, according to an embodiment of the present invention.

FIGS. 2-5 are data flow diagrams;

FIG. 6 is a demonstrative credit card account file.

FIG. 7 presents a flowchart illustrating a method for selling credit accounts over a network in accordance with an embodiment of the present invention.

FIG. 8 depicts a system block diagram in accordance with an embodiment of the present invention.

FIG. 9 presents an overview chart in accordance with an embodiment of the present invention.

FIG. 10 presents a search process flowchart in accordance with an embodiment of the present invention.

FIG. 11 presents a purchase process flowchart in accordance with an embodiment of the present invention.

FIG. 12 presents a data flow chart in accordance with an embodiment of the present invention.

FIG. 13 presents a pricing process flowchart in accordance with an embodiment of the present invention.

FIGS. 14-22 illustrate display interfaces in accordance with embodiments of the present invention.

FIGS. 23-25 are exemplary screen shots of a web portal to the comprehensive debt management system according to another embodiment of the present invention.

FIGS. 26-27 are screen shots of part of an online survey that may be given to collectors according to another embodiment of the present invention.

FIGS. 28-38 are exemplary screen shots of a web portal to the comprehensive debt management system according to another embodiment of the present invention.

FIG. 39 is a screen shot of the alert management interface.

FIGS. 40-43 are data flow diagrams according to another embodiment of the present invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

According to one aspect of the present invention, a system is provided for comprehensive debt management. Debt is typically acquired in the form of portfolios from the issuers of debit (e.g., creditors, such as credit card banks), which are referenced herein as “primary issuers” of debt. The custodian of the present invention is the acquiring party and is referenced as the “secondary issuer” of debt. Such portfolios are normally expansive and may cover a very large geographically region, such as the state of Texas. The system can parse the debt and assign any portion thereof to collection agencies or even directly to individual collectors.

Accordingly, the system is configured to maintain the data relating to the acquisition and processing of debt, analysis of the debt, assignment of debt to collection agencies, receipt of payments from agencies, reclamation of uncollected debt from the agencies, and sale of the recalled debt. The system is preferably a web-enabled electronic data processing system and may be configured further to provide access to online debt sales. The system may be further configured to provide reporting and bench marking functions.

The system may be outfitted with appropriate hardware and software, including, for example, processing and memory storage devices, and client interfaces, preferably web enabled, for input and output of data, reporting tools, databases, etc., which can effect the features described in this document, as well as any other well known or obvious related features not described herein. The components of the system are logical in nature and may be implemented with stand alone processing systems, such as personal computers or servers, or may be combined together or further distributed.

Additionally, off-the-shelf software may be used to implement the present invention, such as, but MICROSOFT .NET, MICROSOFT SQL SERVER, or may be designed and programmed using any combination of languages, such as C++, JAVA, JAVA Script, XML, HTML, SQR, or PLSQL. One should understand that client interfaces can be executed on a PC or the like, via a web browser over an electronic data network, such as the Internet. Further, interfaces may be executed on wireless client devices, such as PDA's or smart phones.

### 1. System Architecture

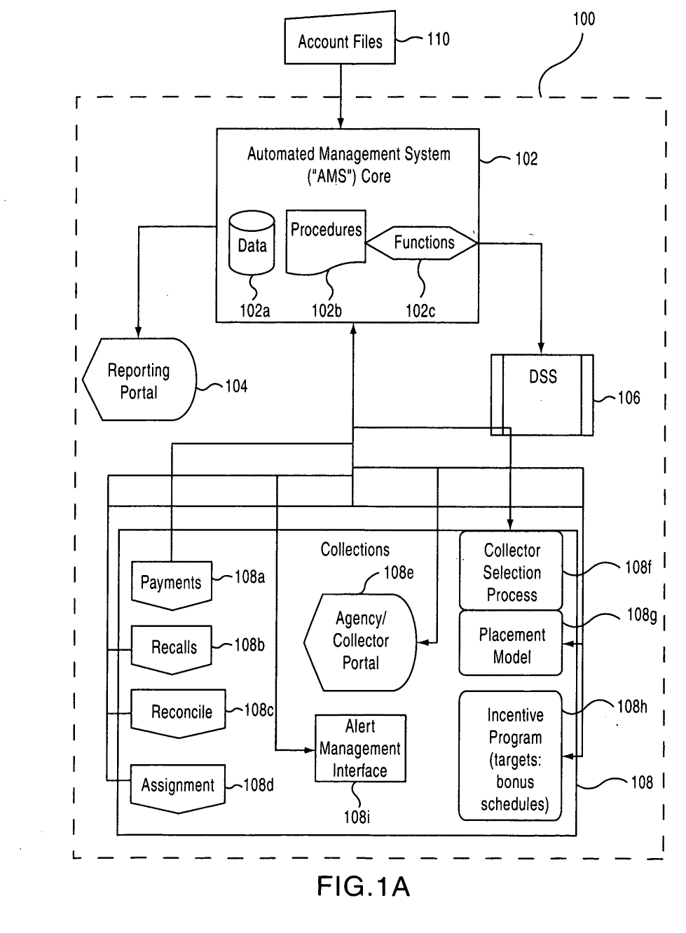

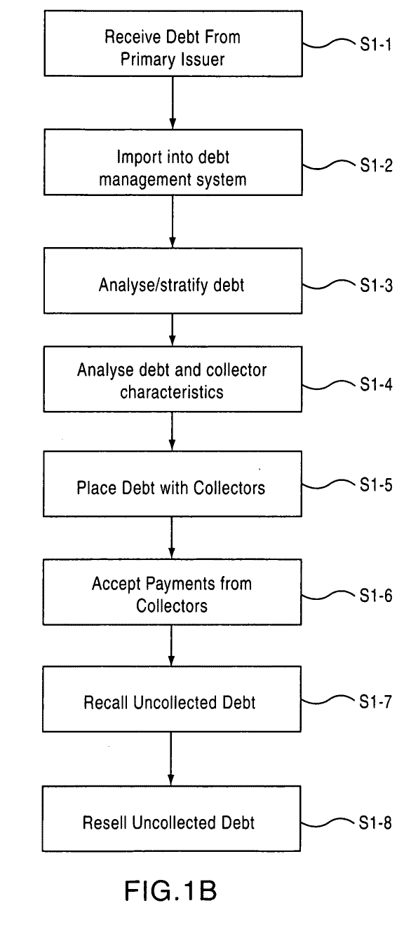

FIG. 1A is a block diagram of an exemplary system according to an embodiment of the present invention. The system 100 may include an Automated Management System (AMS) 102 coupled with a reporting portal 104, a debt sales system,(DSS) 106, and a collections system 108. The AMS 102 is capable of receiving account files relating to debt (issued debt, assigned debt, recalled debt, etc.) and can store data related to the same, on a mass storage device 102a, such as a hard disk drive. AMS includes procedures 102b and functions 102c for performing data maintenance, analyzing data, and for communicating with the reporting portal 102, DSS 104 and collections system 108.

Account files 110 relating to debt portfolios may be input into the AMS 102 via any number of methods, such as by importing, via FTP, or direct data entry through a data entry interface (not shown). Accordingly, account files 110 may be provided electronically or in hard copy. The data for the account files 110 is stored in memory 102a, preferably in a relational database management system (RDMS) such as a SQL database.

System 100 may be configured to facilitate the purchase of portfolios of debt from issuers, the assignment to collectors (e.g., outside collection agencies or in-house collectors), reclamation of uncollected debt after a prescribed period of time, such as 120 days, and the resale of the recalled debt. AMS 102, in conjunction with the collections system 108, performs a novel selection process for the matching of debt with individual agencies and/or collectors. Accordingly, the system 100 collects and maintains data relating to each collector including a personal profile and their collections history. As will be described in further detail below, an analysis may be made of a debt portfolio and debt can be matched with the creditor most likely to collect that particular debt.

Since the value of debt is directly related to the age of the debt (i.e., the amount of time past due), it is preferred that a period of time be prescribed in which collectors whom were assigned debt must collect on the assigned debt. After the expiration of the prescribed period, the debt can be automatically recalled so that it can be resold.

FIG. 1B is a flow diagram of a method for purchasing debt from issuers, managing debt that has been acquired or is in the collection or resale process, placing debt with collectors electronically for collection, collecting debt, and for reselling uncollected debt online, which may be implemented using system 100.

First, at step S1-1, debt is purchased and received from a primary issuer of debt, such as a credit card bank. The debt is typically purchased in a large portfolio for an entire region. The information relating to the debt is imported into the AMS 102 at step S1-2, and made available for analysis, reporting, etc. At step S1-3, the debt portfolio is analyzed and stratified. Such analysis may be automated, such as by the collection system 108. Further details regarding the analysis and stratification are recited below. At step S1-4, the debt and collector characteristics are analyzed in order to determine the best collectors for each type of debt.

At step S1-5, debt is placed by the purchaser of the debt (secondary issuer) with agencies and/or collectors based on the analysis of the debt and on an analysis of the creditors. Debt is placed with the collector that has the highest probability of collecting that debt. That is, an individual account is analyzed and placed with a creditor that is good at collected that type of account. The selection and placement of debt can be automated, such as by the collections system 108. Of course, all the debt in a portfolio need not be placed with agencies and a portion of debt could be collected by in-house collectors. The placement of the debt by the system to the collector with the highest probability is independent of whether the collector is an external (outsourced) resource or an internal employee.

Once debt is placed with collector, the status of the debt is managed in the AMS 102 When a debt is collected, the collector sends a payment to the secondary issuer of the debt. This payment is processed at step S1-6. The information on the payment is imported into the database and made available for analysis and reporting. For example, a payment file may be sent from the collector or agency to the secondary issuer or to the manager of system 100, may be automatically imported into system 100, or system 100 may perform a batch update. The updated payment information is used for the next placements. Accordingly, as the data changes, the system is self correcting.

When any debt goes uncollected for a set period of time measured from when the debt is placed with a collector, for example, 120 days, the debt is recalled by the secondary issuer of the debt, at step S1-7. This recall process is preferably automated with system 100. For example, an email requesting return of uncollected debt may be automatically generated and sent to the collector.

At step S1-8, recalled debt is then resold via the DSS 106, preferably online. A portal may be provided to prospective purchasers that allows a prospective purchaser to search for and purchase existing debt portfolios, customized debt portfolios, or individual debt accounts. The DSS 106 manages the resale of debt and the transfer of the debt to purchasers.

The system and method of the present invention are described in such terms as if it were implemented for or by secondary issuers of debt. However, it is contemplated that primary issuers of debt could use the present invention to manage assignment to in-house collectors or to outside collection agencies, payments received, and the sale of its debt. Further, collection agencies themselves could use the present invention to select which collectors as assigned which debt. The present invention also provides powerful trending and reporting tools, which could be useful by any player in the debt market.

### 2. The AMS

The AMS 102 receives and maintains data for system 100 and manages the overall functionality of the system 100. In this sense, it is the core of system 100. Accordingly, AMS 102 is configured to communicate with the reporting portal 104, the DSS 106 and the collections system 108 in order to share information necessary to perform their functionality. The AMS 102 maintains the business rules of the company by allowing preset collection periods and statistically derived goals based on the debt placed, normal manual functions of tracking goals and recalling debt are under full automation. Further, data custodian, administration and security tools should be provided.

Of course, FIG. 1 is only an exemplary system architecture and one skilled in the art will readily understand that the present invention may be implemented by a more centralized architecture or a distributed architecture and the functions of the AMS 102, reporting portal 104, DSS 106 and collections system 108 could be consolidated into a central processing unit or distributed accordingly.

When debt is first acquired, the account data for the portfolio is entered into AMS 102, such as via an import process. AMS 102 is configured to stratify the debt automatically and can calculate and provide valuable metrics on each portfolio. For example, it would be helpful to know how much of a portfolio is in each state, how many accounts are for a certain dollar range, etc. Comparison of the debt characteristics against previous portfolios or outside data can provide an important management tool for liquidation predictions and decision making support.

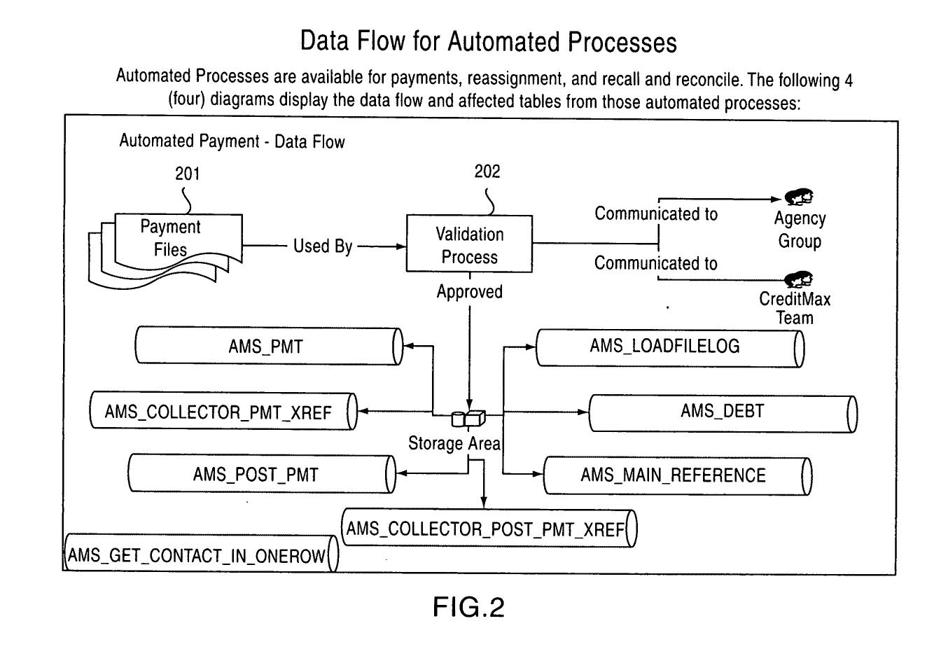

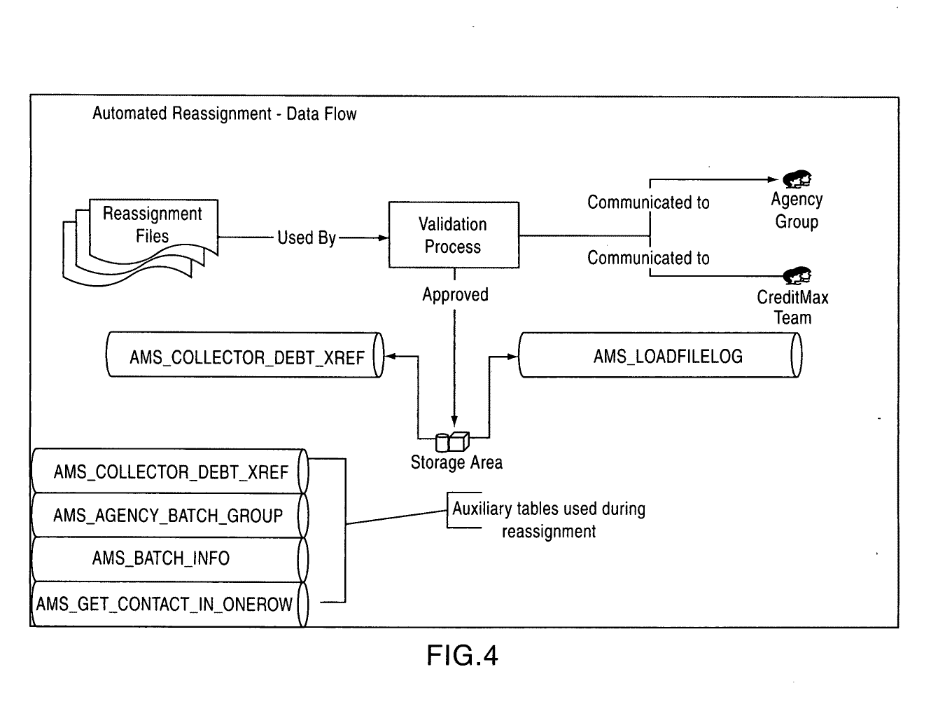

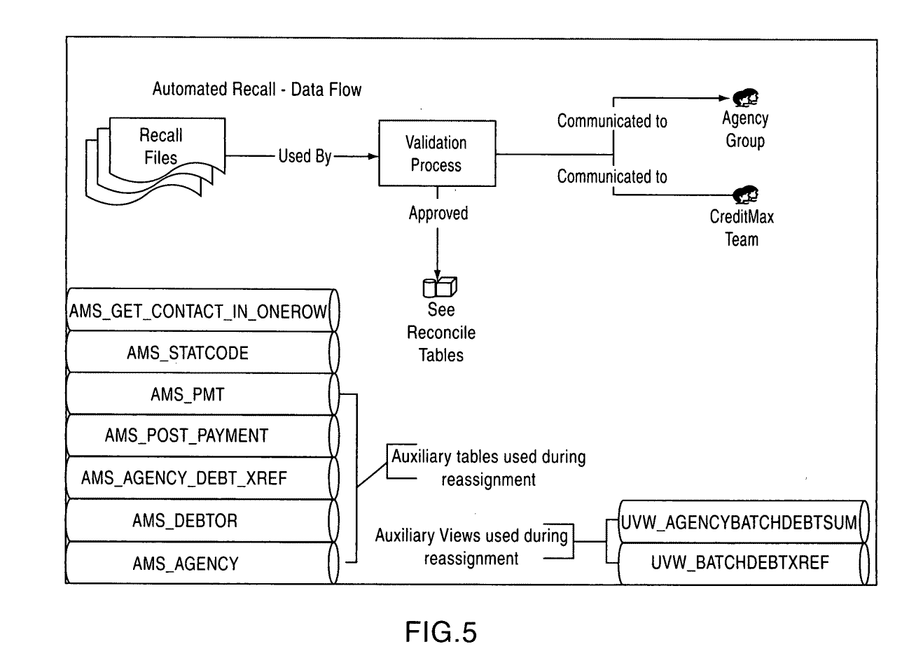

The AMS 102 further provides automated data processes for, e.g., recording payments, recalling debt and reassignments, and reconciliation of stored data. FIGS. 2-5 respectively show data flow diagrams for each of these exemplary processes. Note that a validation process is used to first validate and approve incoming data files before the data base is updated. These processes are described in more detail below in connection with the description of the collections system 108.

a. Data Model

Generally, the AMS 102 maintains data for the entire system 100, which may include data relating to the debt portfolios, collection agencies, individual collectors (including profile and survey data), historical collections and payments, and resale. This data may be used or modified through processes performed by the other subsystems. Appendix A is an Entity Relationship Diagram (ERD) showing an the data model for system 100. This ERD is exemplary in nature and is not intended to limit the present invention.

AMS 102 serves to maintain the data through standard database operations either automatically or manually. Database processes, procedure and function may be used to update the data. As an example, as payments actions are taken, the appropriate data may be updated automatically by the AMS 102, such as via a nightly batch process. For example, as shown in FIG. 2, when payments are received, the payment files 201 are validated 202 and then, the appropriate data files are updated automatically. Or, an interface may be provided for manual adding, changing and deleting of data.

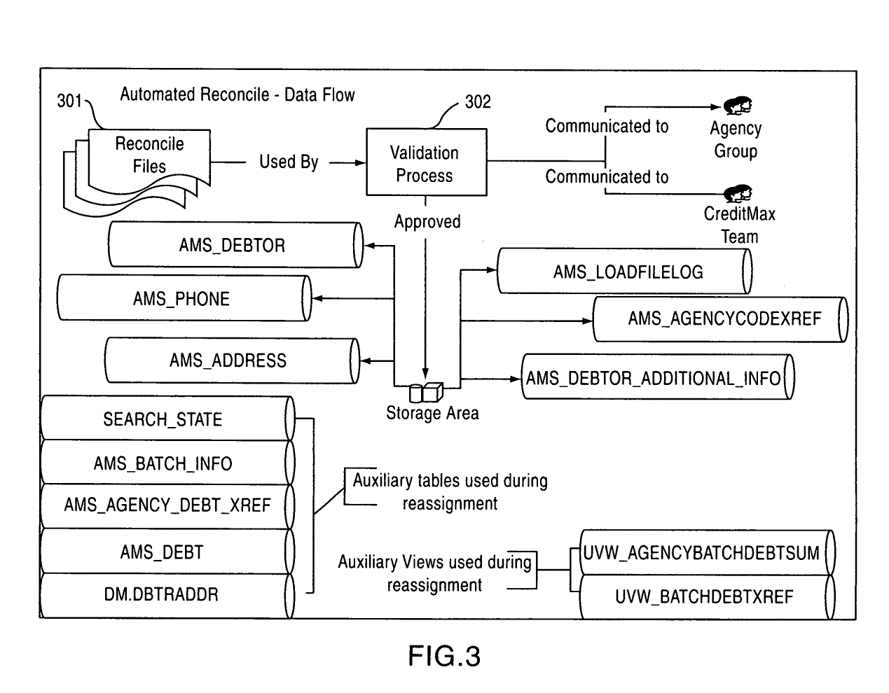

Since data may also be maintained in other sources, for example, by collection agencies, data is preferably reconciled on a periodical basis in order to maintain its accuracy. For example, as shown in FIG. 3, reconcile files 301 may be received electronically and validated 302, and if approved by the validation process, the appropriate tables are automatically updated as necessary. Data that is conducive to real-time updates are preferably updated in real-time or near real-time.

In order to perform data manipulation, a number of procedures, functions or scripts may be employed and executed by the AMS 102. Such procedures, etc. can be called by any subsystem in system 100. Appendix B includes a list of procedures 102b that the AMS 102 may execute in order to perform its functions. This list is exemplary in nature and is not intended to limit the present invention.

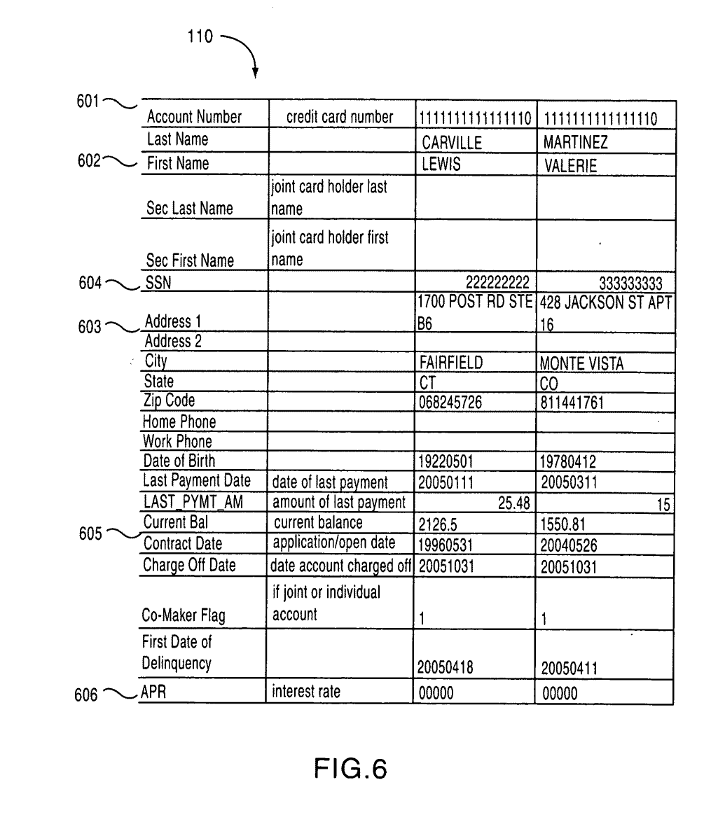

The AMS 102 system should be configured to parse account files 110 for entry into its database. The account files 110 can be EXCEL files or the like and identify the account debt information and account holder information. For example, demonstrative credit card account files are shown in FIG. 6. As shown, an account should include, for example, a credit card number 601, name 602 and address 603 of the account holder (debtor), social security number 604, and other account information such as the size of the debt 605, the rate 606, etc. Of course, these examples are not meant to limit the present invention.

### 2. Reporting Portal

Reporting portal 104 is coupled with the AMS 102 and configured to provide reporting for the entire system 100 and preferably allows for output to a printer, to a screen or electronically to a file. An off-the-shelf system that is compatible with the AMS database may be used, such as CRYSTAL REPORTS, or custom reports can be utilized, or a combination thereof. A list of exemplary report scripts are attached at Appendix C hereto. The reporting portal 104 preferably includes canned reports or queries that can be accessed by the secondary issuer of the debt or the debt owners, which provide metrics on how much debt is outstanding, how much is being collected, how well each agency is performing, how individual collectors are performing, etc.

### 3. The DSS

The DSS 106 is coupled with the AMS 102 and configured to perform the functions relating to the resale of recalled debt. As will be described in further detail below, uncollected debt is recalled from collectors after a prescribed window of time closes. This recalled debt is then sold. The debt may be sold individually or repacked with other debt. U.S. Provisional Application No. 60/709,099, which has already been incorporated herein, includes further details regarding an, exemplary DSS 106.

It is contemplated that the DSS 106 could be used by an issuer of debt, in order to manage sales and create liquidity with respect to its debt. Debt for sale could be updated regularly, such as daily, in order to change the mix and create interest. Further, instruments such as futures or options on the debt may be sold or traded as well.

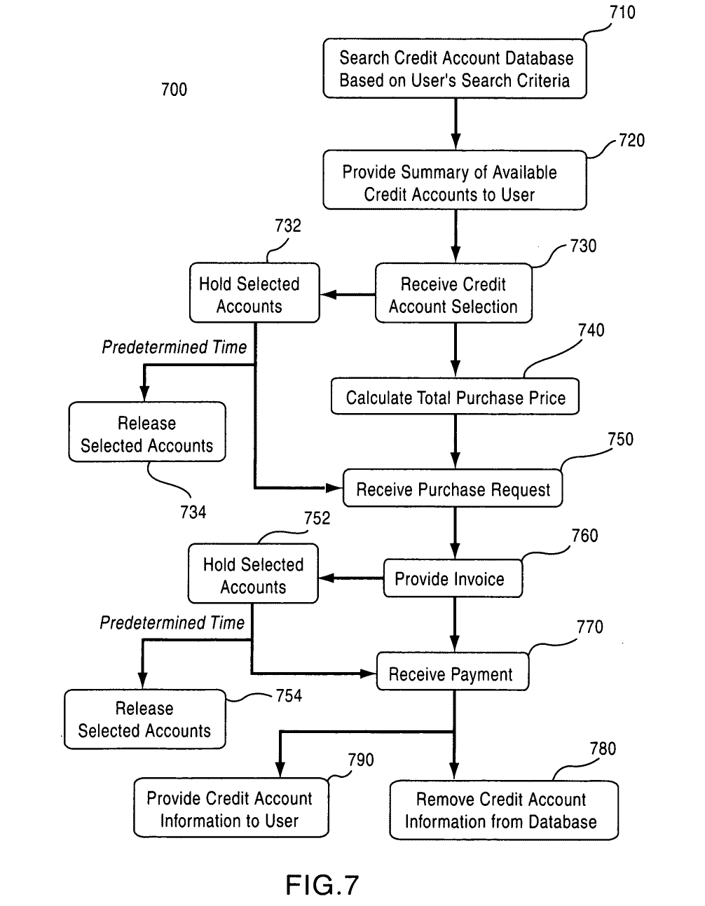

FIG. 7 is a flowchart illustrating a method for selling credit accounts over a network in accordance with an embodiment of the DSS 106.

In an embodiment, method 700 includes searching (step 710) a credit account database for available credit accounts based on search criteria received from a user; providing (step 720) a summary of available credit accounts to the user, including a purchase price for each available credit account; receiving (step 730) a selection of available credit accounts from the user; calculating (step 740) a total purchase price for the selected credit accounts; receiving (step 750) a purchase request from the user; providing (step 760) an invoice to the user; receiving (step 770) a payment from the user; and removing (step 780) the selected credit accounts from the credit account database.

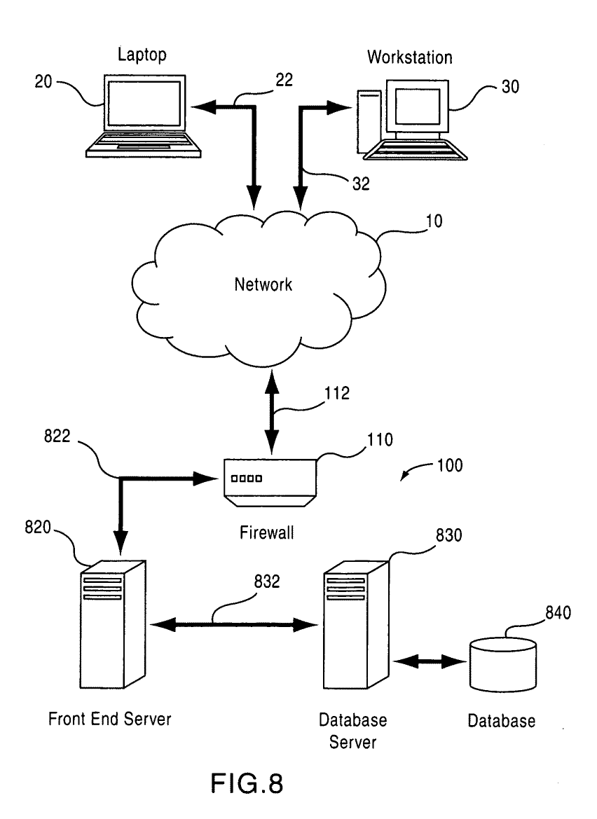

FIG. 8 is an exemplary system architecture diagram of the AMS in accordance with an embodiment of the present invention.

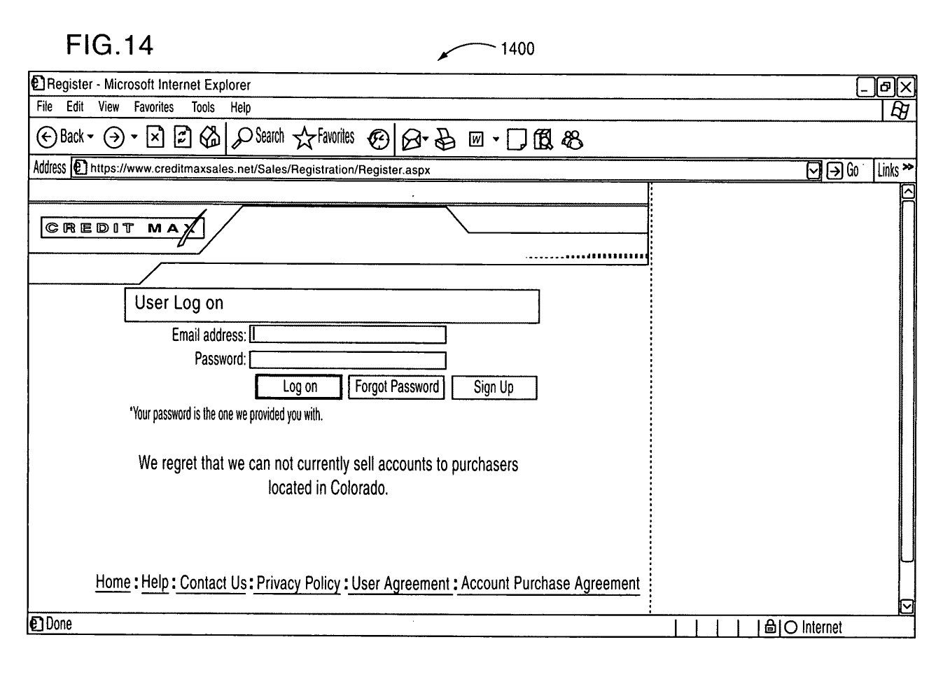

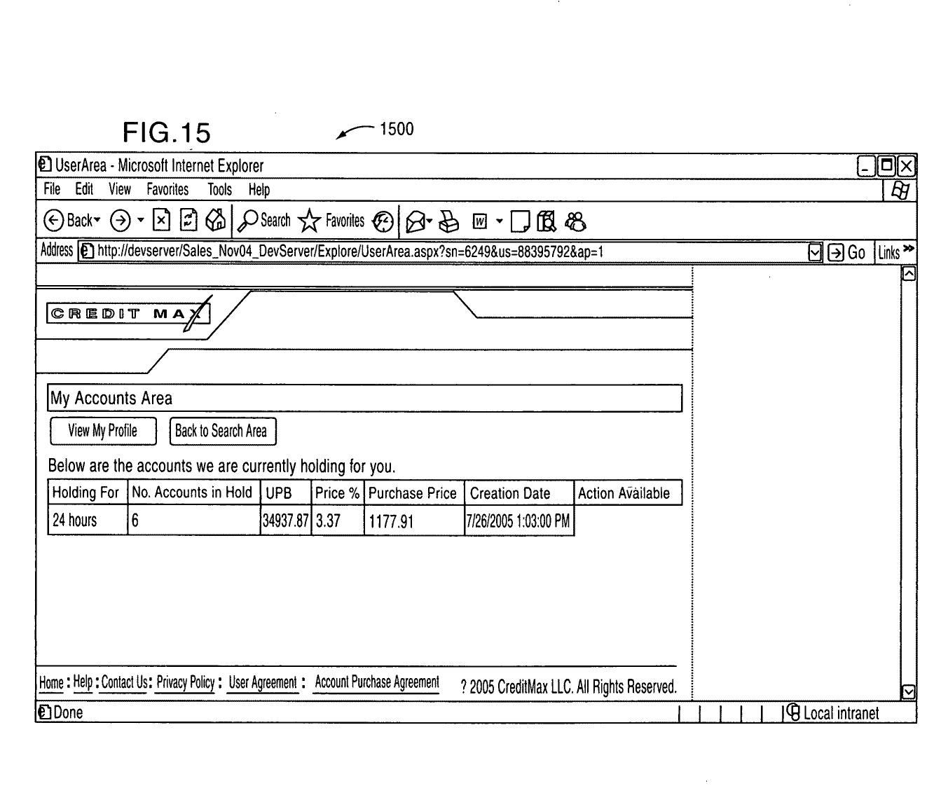

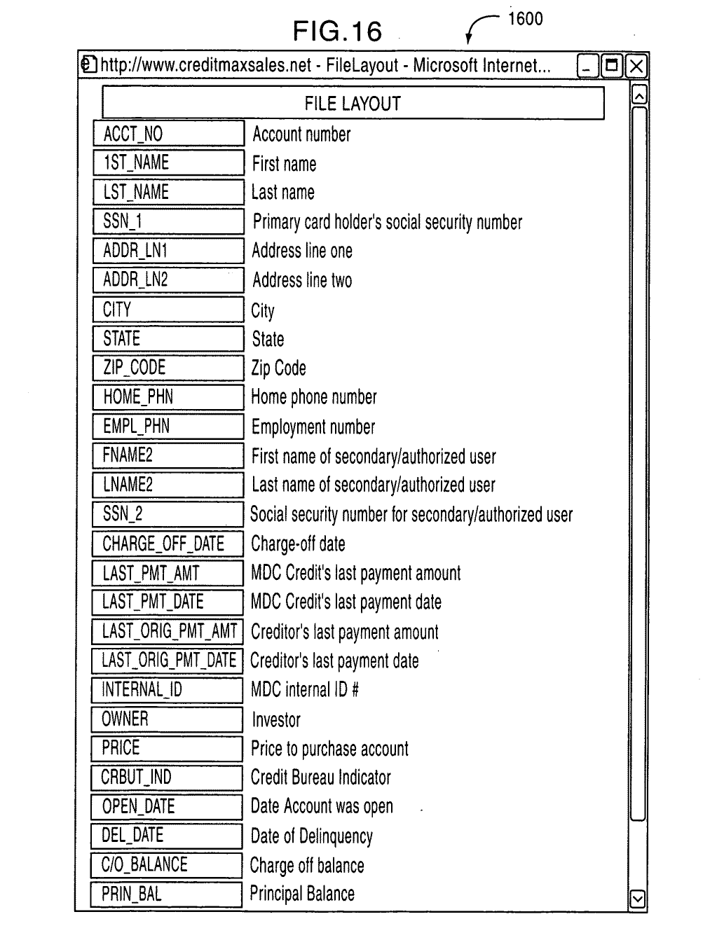

A user initially logs into front end server 820 from laptop 20, workstation 30, etc. A user login screen 1400 is shown in FIG. 14. The data connection between the user's computer and front end server 820 may be encrypted using any one of a number of well-known methods for encrypting data transmitted between network computers, such as, for example, HTTPS, etc. If desired, a summary of the user's accounts may be displayed. An exemplary user account summary display 1500 is shown in FIG. 15. The layout of a typical credit account file, within database 840, may also be displayed to the user, as shown, for example, in the credit account file layout 1600 in FIG. 16.

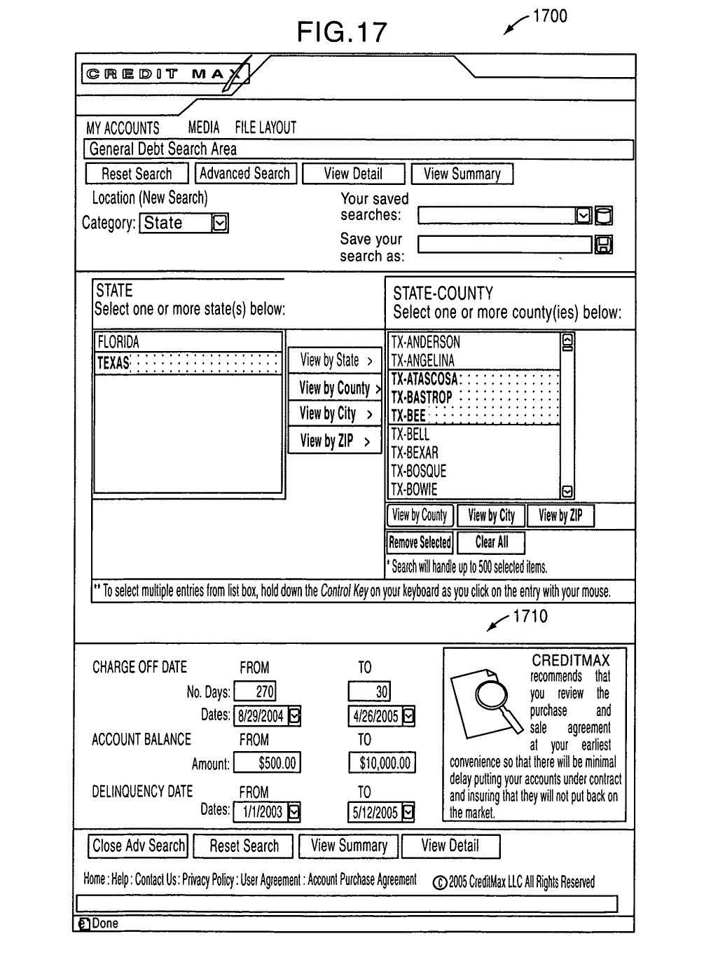

To begin searching (Step 710) for available credit accounts, various search criteria are entered by the user, including, for example, a state, a county, a city, a zip code, a charge-off date, an account balance, a delinquency date, etc. See, e.g., the search screens 1700 and 1710 of FIG. 17. Using the search criteria specified by the user, front end server 820 sends a search request to database server 830 over network 832. Database server 830 queries credit account database 840 based on the search request, and sends a reply to front end server 820 that includes a list of available credit accounts.

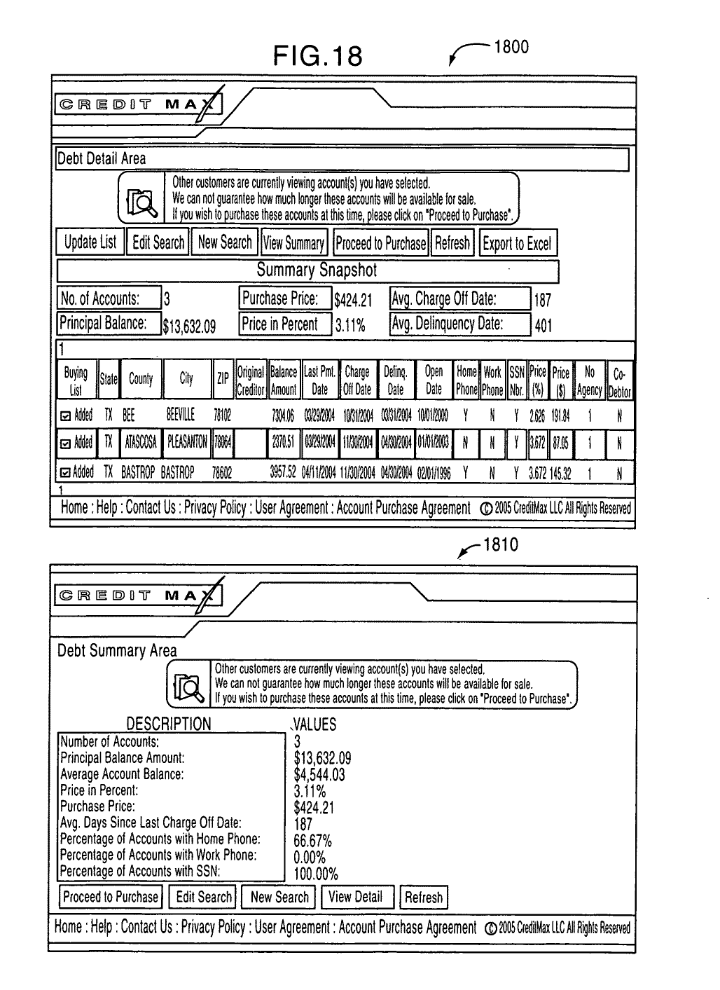

Front end server 820 then provides (Step 720) a summary of available credit accounts to the user, including a purchase price for each available credit account. An exemplary summary is shown in FIG. 18. Debt detail area 1800 can include the state, county, city and zip code where the debt is located, the identity of the original creditor, the balance amount, the last payment date, the charge off date, the delinquency date, the open date, whether the account includes a home or work phone number, a social security number, the price percentage, the price amount, the number of agencies involved and whether there is a co-debtor.

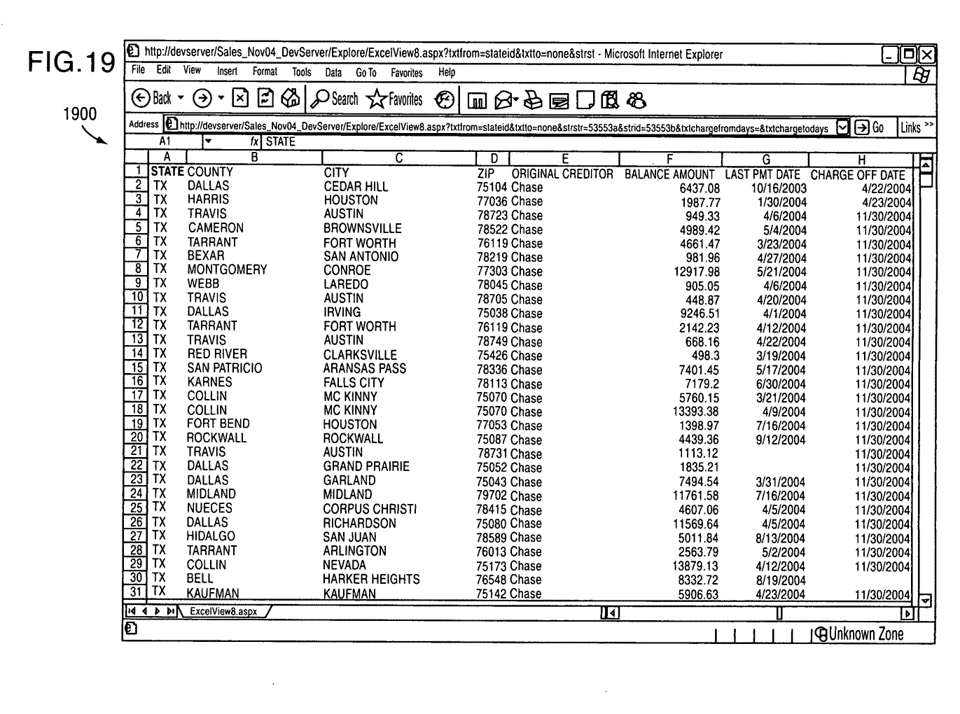

Front end server 820 then receives (Step 730) the selection of available credit accounts from the user and calculates (Step 740) a total purchase price for the selected credit accounts. A summary of the selected credit accounts may be displayed to the user, including the total purchase price. For example, debt summary area 1810 includes the number of accounts, principle balance amount, average account balance, price as a percentage, purchase price, average days since last charge off date, percentage of accounts with phone numbers or social security numbers. The available credit accounts may also be exported to Excel and viewed by the user, as shown in FIG. 19. As shown, the summary 1900 is in a grid format.

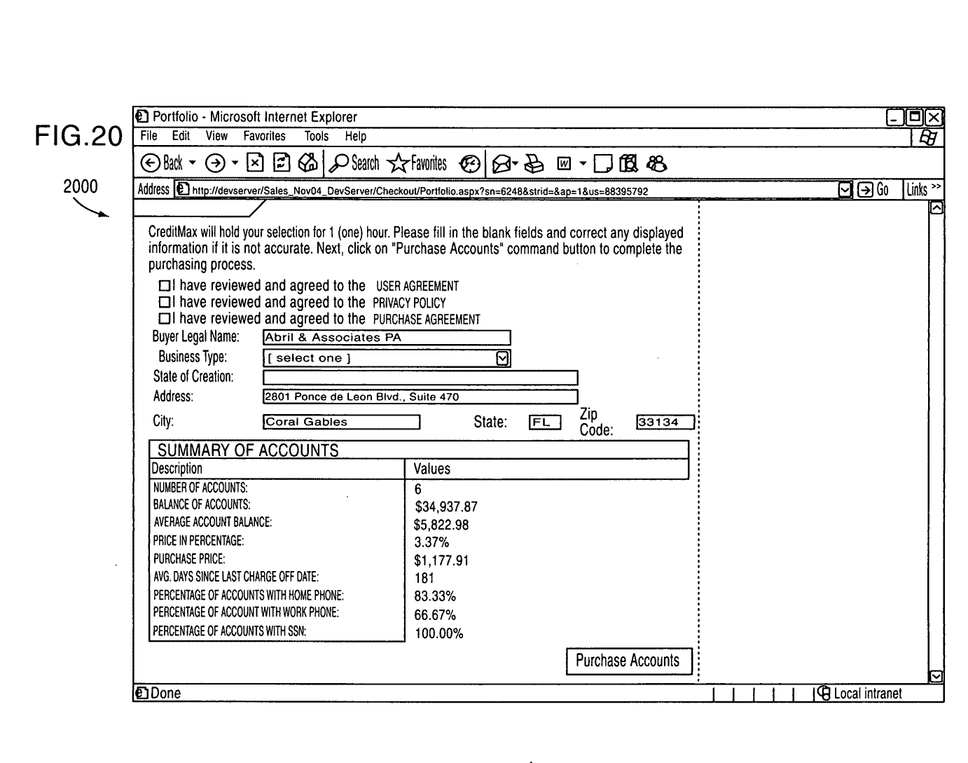

Once selected, the user then purchases the credit accounts. Front end server 820 receives (step 750) the purchase request from the user. The received purchase request may also include an acknowledgement of, a review of and an agreement to a purchase agreement, a user agreement and a privacy policy. For example, FIG. 20 shows summary screen with a purchase account area 2000, which includes the same information as shown in FIG. 18.

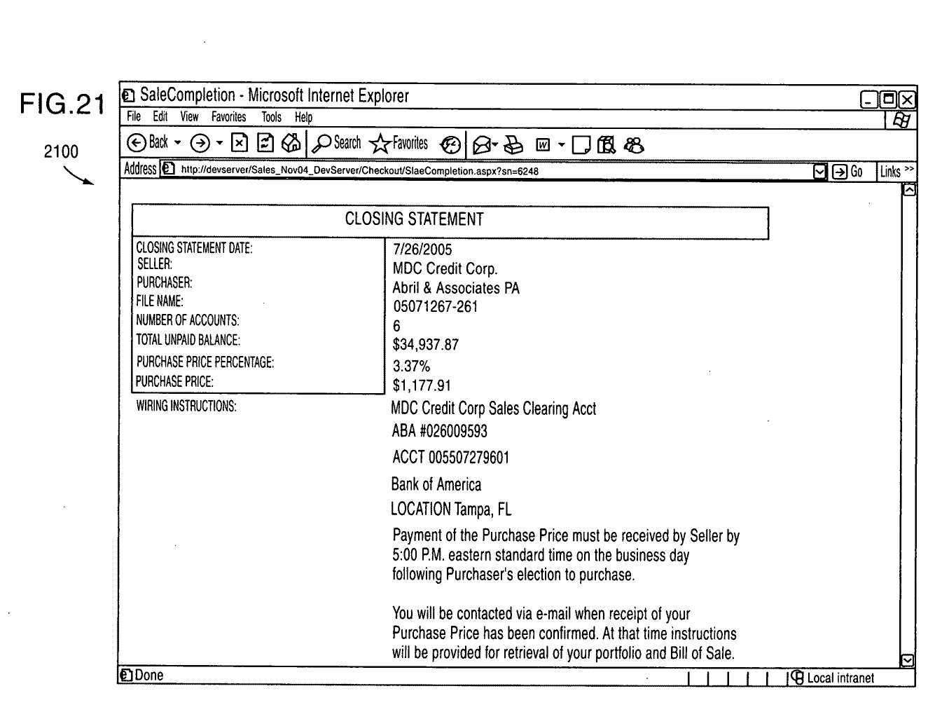

In response to receiving (step 750) the purchase request, front end server provides (step 760) an invoice to the user. An exemplary closing statement 2100 shown in FIG. 21. After payment is received (step 770) from the user, the purchased credit accounts are removed (step 780) from database 840. For example, front end server 820 may send a request to database server 830 to remove the purchased credit accounts from database 840.

The process 700 may also include, after receiving (step 730) the selection, holding (step 732) the selected credit accounts for a predetermined time period, such as, for example, 1 hour, and if the purchase request is not received (750) within the predetermined time period, releasing (step 734) the selected credit accounts.

Process 700 may additionally include steps of, after receiving (step 750) the purchase request, holding (step 752) the selected credit accounts for another predetermined time period, such as, for example, 24 hours; and if the payment is not received (step 770) within the predetermined time period, releasing (step 754) the selected credit accounts. In an embodiment, holding (steps 732, 752) the selected accounts includes marking the appropriate records within credit account database 840 as “unavailable” for new searches, while releasing (steps 734, 754) the selected accounts includes marking the appropriate records within credit account database 840 as “available” for new searches. Mechanisms for locking database records are well-known in the art and may be adapted for use herein.

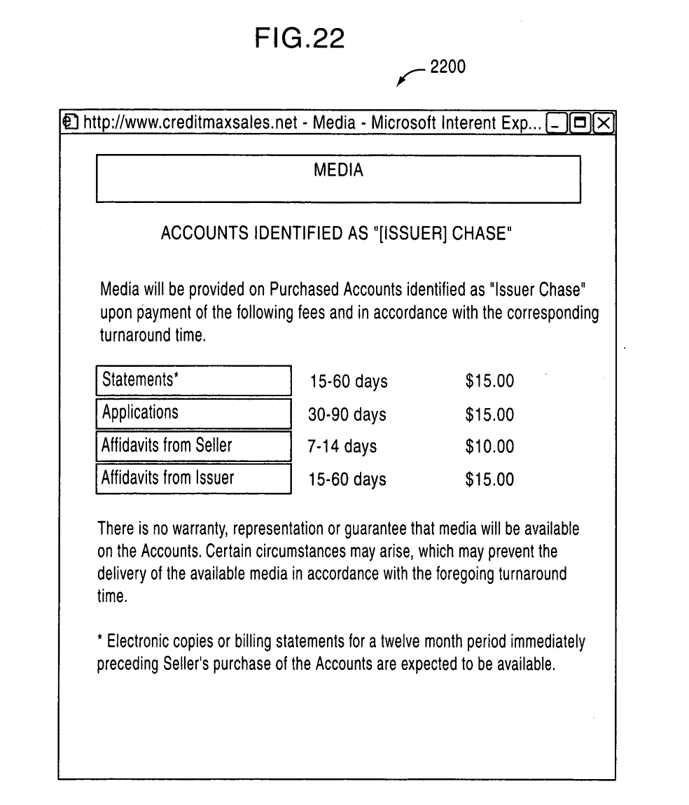

After receiving (step 770) the payment from the user, information associated with the purchased credit accounts may be provided (step 790) to the user. This information may include, for example, a debtor name, a debtor address, an original creditor, a balance amount, a last payment date, a charge off date, a delinquency date, an open date, a home phone number, a work phone number, a social security phone number and co-debtor information. In one embodiment, media is provided from the original credit account holder. See, e.g., purchased account media information 2200 (FIG. 22).

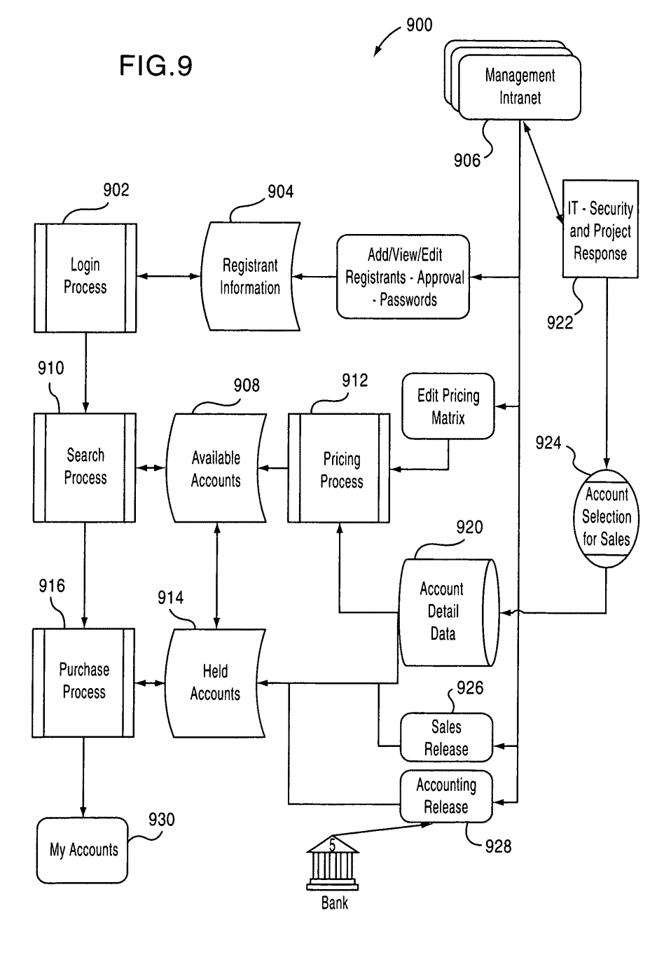

FIG. 9 is an overview data process diagram 900 illustrating an exemplary data processing arrangement in AMS. A login process 902 uses registrant data 904, which can be maintained by via management intranet 906. Available account information 908 can be accessed by a search process 910, a pricing process 912 and is connected to held accounts information 914. A purchase process 916 accesses the held accounts data 914. The pricing process 912 also receives account detail data 920.

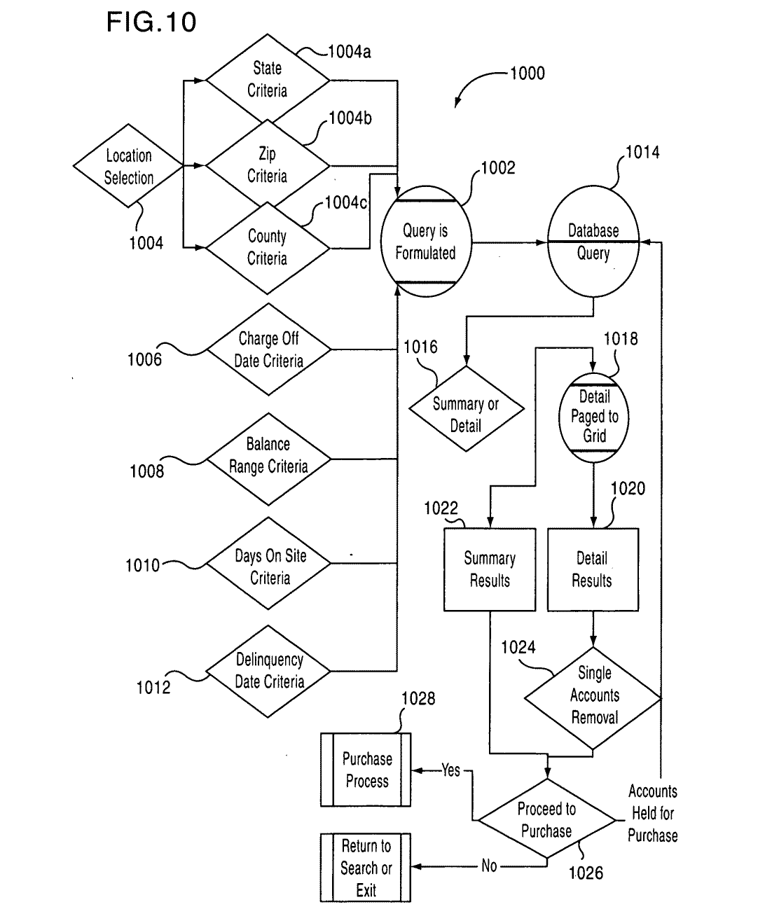

FIG. 10 is a flow chart of an exemplary search process (910). As shown, a query 1002 can be formulated from a number of criteria 1004-1012. The query is executed against the database 1014 and the results can be in summary and drilled down to any level of detail 1016-1024. Accounts can be held for purchase 1026, which would feed into the purchase process 916.

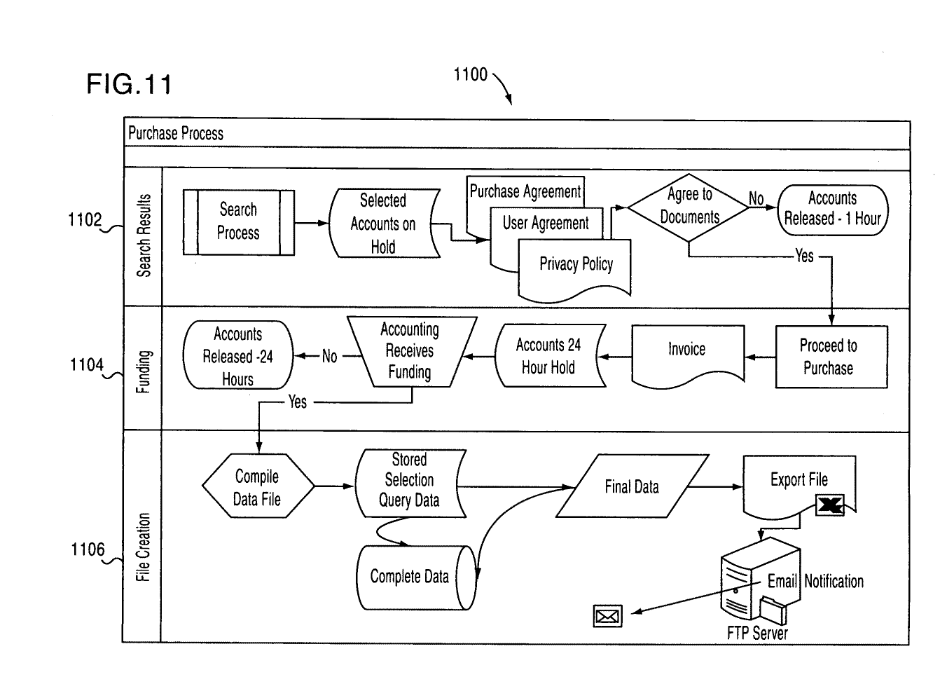

FIG. 11 illustrates an exemplary purchase process flow. The purchase process includes three sub-processes: search results 1102, funding 1104, and file creation 1106. The search results sub-process 1102 includes steps for going through various purchase agreements, user agreement, and privacy policies for held accounts. After a period of time, held accounts can be released.

In the funding sub-process 1104 invoices are processed and the process is moved to the file creation sub-process for the paid accounts. None paid accounts can be released after a predetermined mount of time.

In the file creation sub-process 1106, a file is created and exported based on the purchase. The file preferably contains all the data associated with the purchased account(s). Files can be sent by email, FTP or other known means.

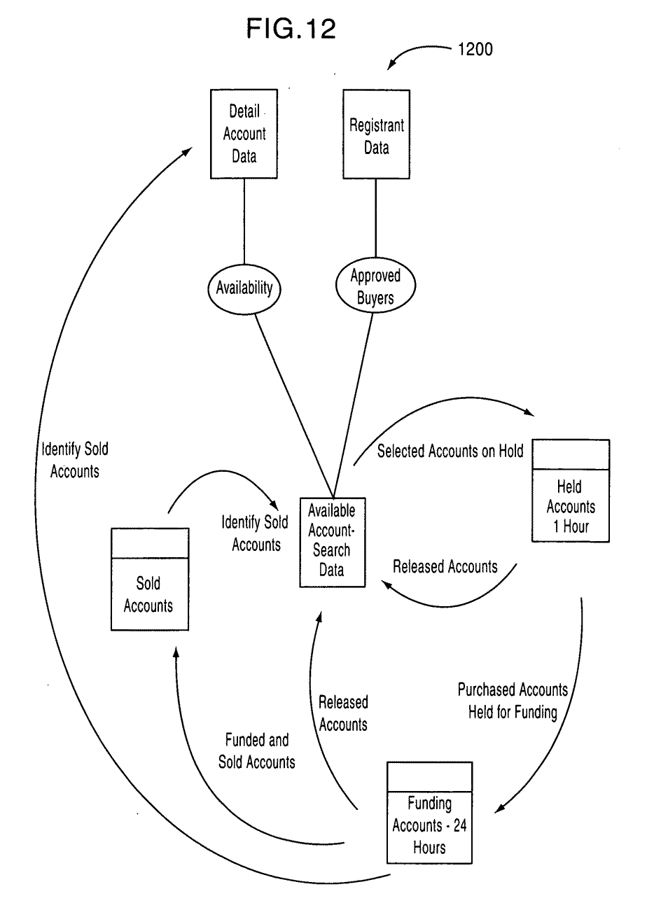

FIG. 12 is a data flow chart overview showing account data during the purchase process.

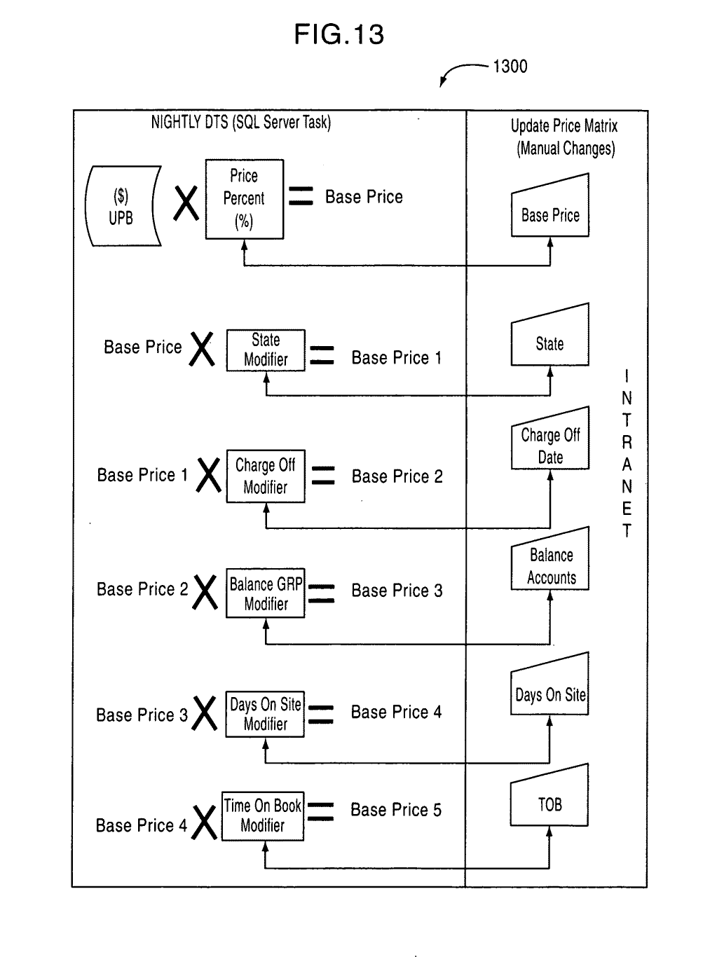

FIG. 13 illustrates a pricing process that can be run on a periodic basis, such as nightly, in accordance with embodiments of the present invention.

The purchase price for each credit account within credit account database 840 may be calculated by applying a series of price modifiers to a baseline price. In the embodiments depicted within FIGS. 9 and 13, a price matrix may include several price modifiers, which may be updated by an operator of the debt sale system. The price matrix may include, for example, a base price percent modifier, a state modifier, a days-since-charge-off modifier, a balance size modifier, a days-on-site modifier and a time-on-book modifier. These modifiers may be cumulatively applied to the baseline price to arrive at purchase price, as depicted within FIG. 13. Intermediate base prices 1-5 are also depicted within FIG. 13. Other modifiers may also be used, including, for example, a county modifier, a city modifier, a zip code modifier, days-since-last-payment modifier, a product type modifier, an asset modifier, a mortgage modifier, a FICO score modifier, a marital status modifier, an income modifier, a debtor status modifier and a credit history modifier. In one embodiment, database server 830 updates the purchase price of each credit account within credit account database 840 periodically using the modifiers within the price matrix.

As noted above, FIGS. 14-22 are screen shots of display interface screens in accordance with embodiments of the present invention. FIG. 14 illustrates an exemplary user login screen 1400. FIG. 15 illustrates an exemplary user account summary screen 1500. FIG. 16 illustrates an exemplary credit account file layout 1600. FIG. 17 illustrates an exemplary search screen 1700 and 1710. FIG. 18 illustrates an exemplary debt summary and detail screen 1800 and 1810. FIG. 19 illustrates an exemplary account detail view 1900. FIG. 20 illustrates an exemplary purchase account summary screen 2000. FIG. 21 illustrates an exemplary invoice or closing statements 2100. FIG. 22 illustrates an exemplary purchased account media information screen 2200. The display fields on each of the screen are self evident.

While this invention has been described in conjunction with specific embodiments thereof, many alternatives, modifications and variations will be apparent to those skilled in the art. Accordingly, the preferred embodiments of the invention as set forth herein, are intended to be illustrative, not limiting. Various changes may be made without departing from the true spirit and full scope of the invention as set forth herein.

### 4. Collections System

The collections system 108 is coupled with the AMS 102 and configured to select and place debt with collectors (assignment), to maintain and implement an incentive program, to process payments, recall debt and reconcile data. Accordingly, the collections system 108 may includes a payments module 108a, a recalls module 108b, a reconcile module 108c an assignments module 108d, an agency/collector portal 108e, a collector selection process 108f, a placement model 108g, an incentive program module 108h, and an alert management interface 108i.

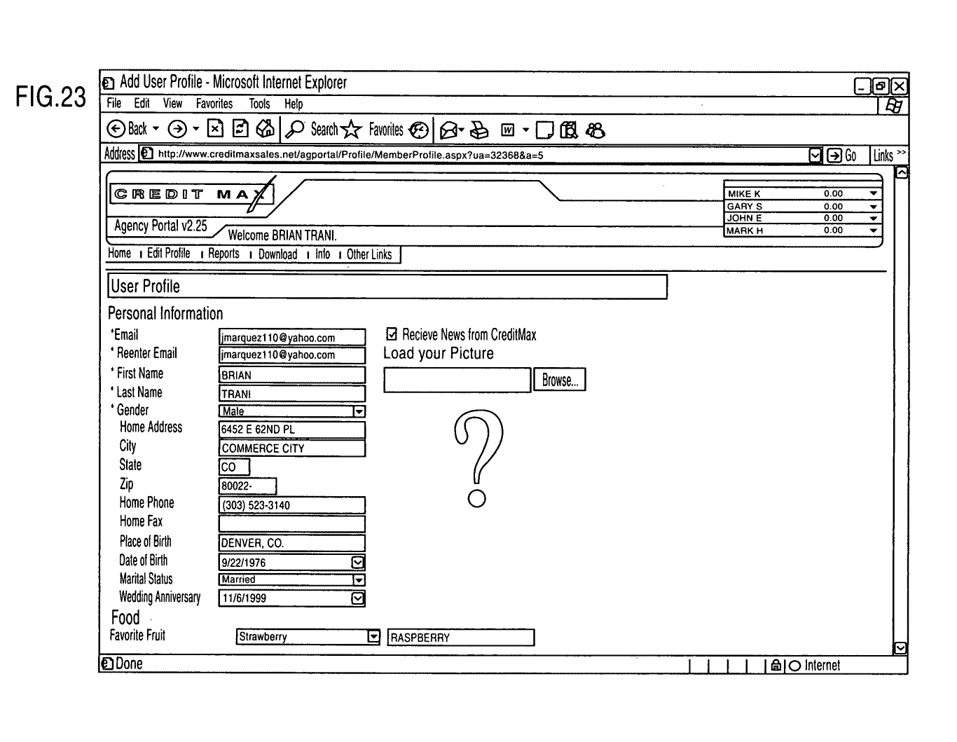

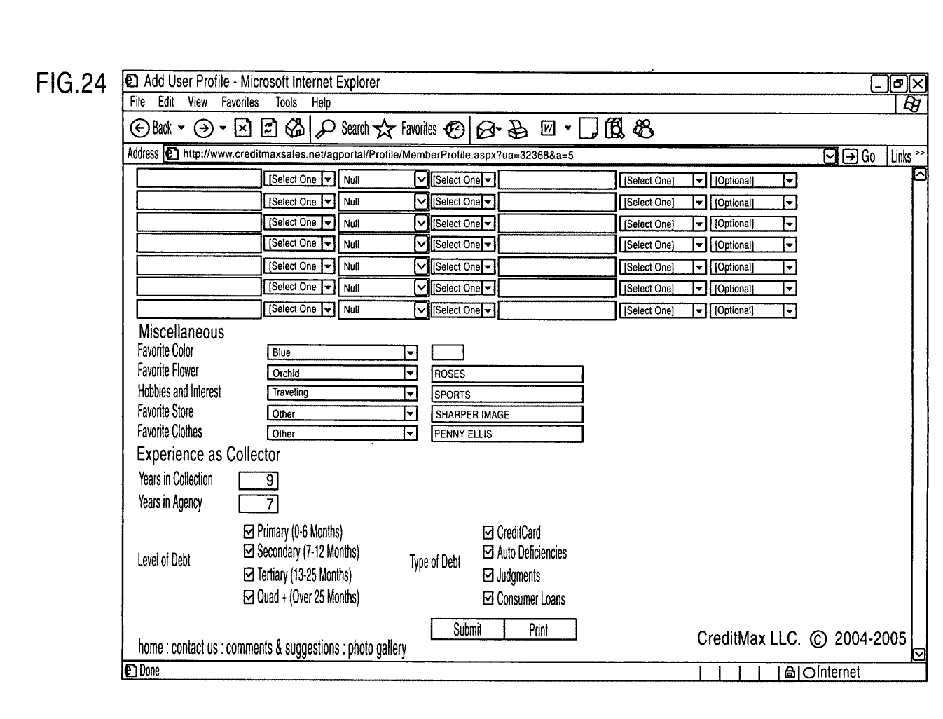

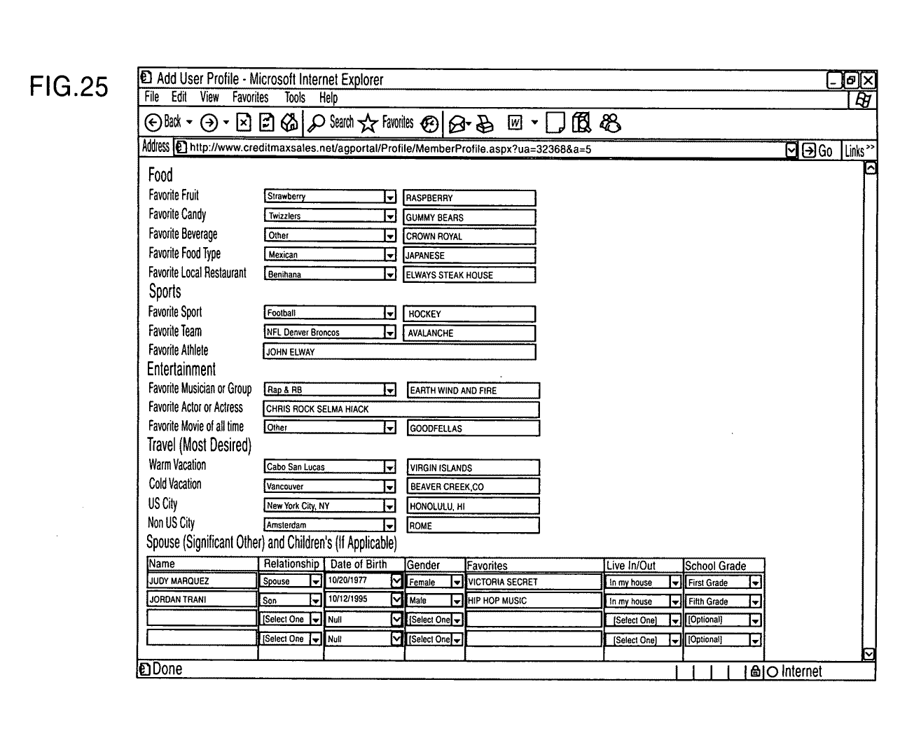

With respect to the performance of these functions, three buckets of information are collected. For the incentive and bonus program 108h, personal information relating to each collector is maintained. Such personal information should be detailed and can be intimate. For example, FIGS. 23-25 are screen shots of forms used to collect collectors' personal information. As can be seen, “favorites” type information is collected for use in incentive and bonus program 108h. Such favorites information might include favorite sports teams, activities, names and birthdays of children and spouse, anniversary date, and desirable vacation hot spots.

History transaction data is also collected, preferably at least two years worth, for use in, inter alia, the selection and placement modules. This historical transaction data should include data relating to the performance each collector and/or agencies. It is preferred that this information be as detailed as possible. For example, historical data may include each characteristic of each account for which payment was collected vel non, the date when a collection was made, the amount of the collection, etc. This historical data can be used to identify the most successful collectors for every possible kind of debt.

Also, survey information is collected from each collector. For example, a questionnaire of psychological questions may be give to each collector in order to develop a knowledge base for each collector. The knowledge base is developed from responses to the psychological surveys and can be used to create collector profiles. This information is very useful for better understanding each collector and can also be taken into account in the selection and placement process.

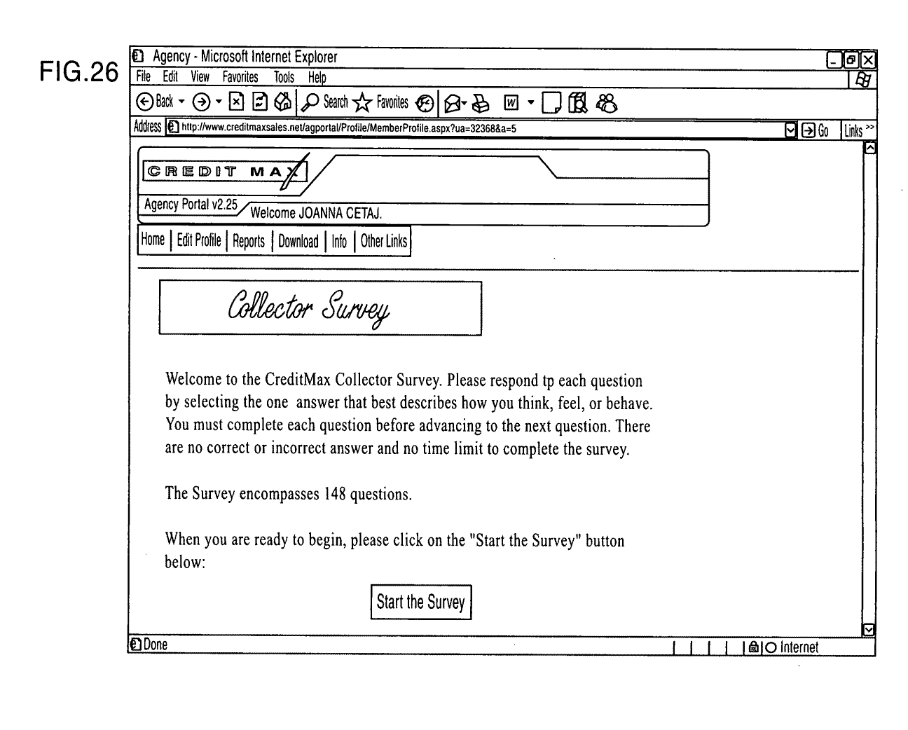

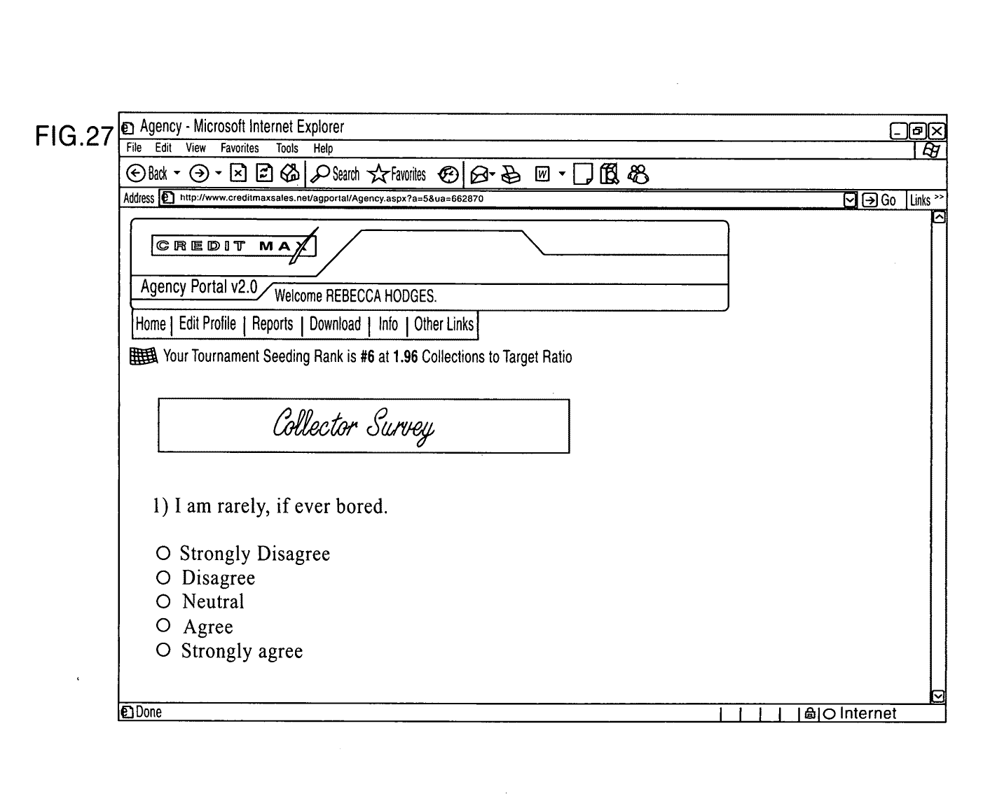

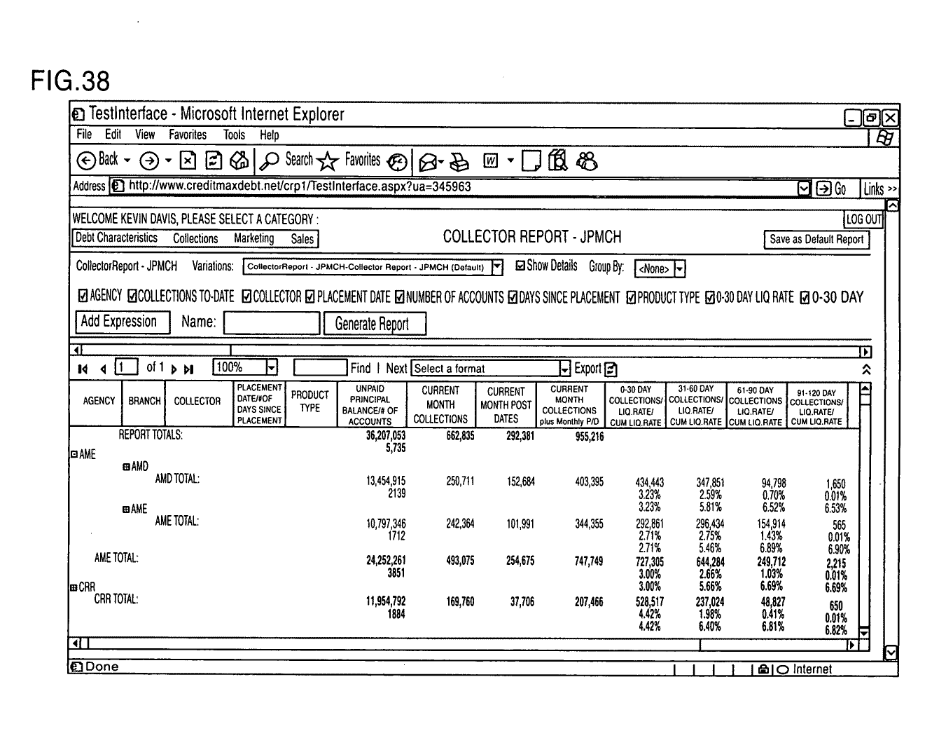

The information may be collected via the agency/collector portal 108e. FIGS. 23-39 are screen shots of exemplary portal pages. FIGS. 26-27 are screen shots of an online survey that may be given. Note that while only one question is shown, however, psychological surveys for employees with multiple questions are well known.

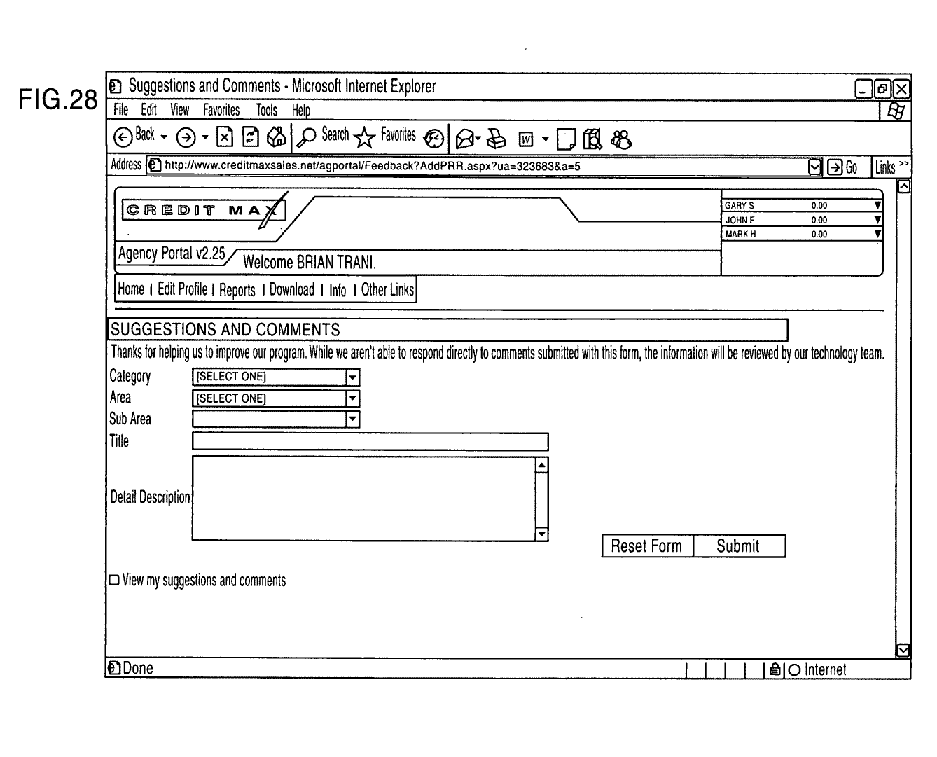

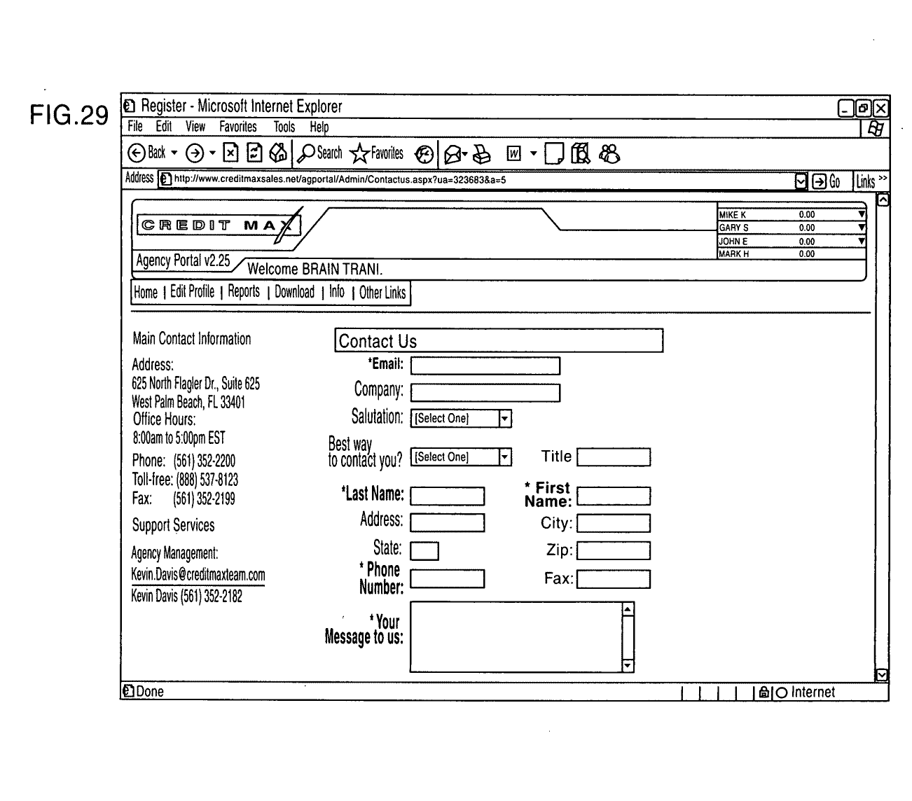

FIG. 28 is a screen shot of a form for collecting suggestions and comments. FIG. 29 is a screen shot of a form for contacting the manager of system 100. FIGS. 23-25 are screen shots of a form for collecting collector profile information, including personal information like favorite color and professional information such as years of experience and types of debt collected.

a. Payments Processing

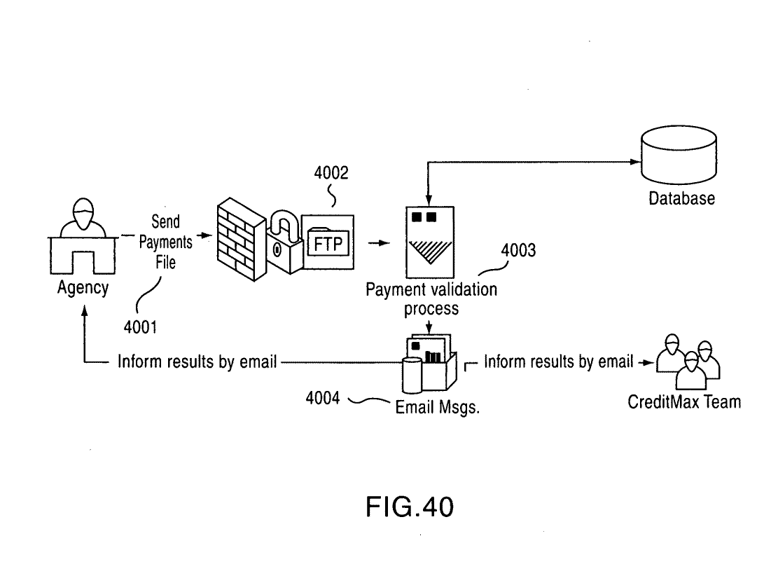

FIG. 40 shows a payment flow according to one embodiment. Payments in the form of pmt files 4001 are sent up to an FTP site 4002, preferably as payments occur or once a day. The data in the pmt files are applied to existing data to: determine validity, post payments against accounts, manage post dated check information, and report the success of the agency and collectors. The payment validation process 4003 preferably uses a uniform file naming convention, format, and procedure in order to assure correct application of your payment data. Inconsistent or incorrect data is either returned in whole as unable to process; or in part as exceptions that were not processed.

Emails 4004 can be sent daily to the agencies regarding the operation of system 100, which relay the results of the processing. The results email 4004 may include information about payments successfully processed and also about payments that for some specific reason were not processed. Examples of email messages that may be generated in connection with the processing of the payment are shown Appendix D.

Payments Format

File Name—There is a standard naming convention for the daily payment file since the site is utilized for multiple purposes by the agency. This naming convention will allow the system to identify the file expected and process it accordingly. The expected name for the payment file should follow this format:

PMTXXXMMDDYY.xls

PMT represents Payment Process, XXX represents the 3 letter agency code, which will be given to you by CreditMax client services, MMDDYY is the 2 digit month (MM), 2 digit day (DD), and the 2 digit year (YY) of the day the file was uploaded.

Agencies prior to implementation of this process can be grandfathered in and have specific names that are accepted for their agency.

File Format

The files can be sent in any of three different formats, an excel spreadsheet, a comma-separated values (CSV) text file, or a tab-delimited text file.

The main columns required are Debt ID, Payment Date, Payment Amount, Collector, Type, Comment, and Reference Number. The order of these fields is not important other than the fact that they need to stay consistently the same from the original file.

Debt ID is the unique identifier assigned to the account for the system 100.

Payment Date is the date of the payment or post date for post dated checks.

Payment Amount is the amount of the payment. For back outs, this will be a negative number.

Collector is the name of the collector associated with the payment. This is in the same format as the assignment files, first name and last name separated by a space. This must match the name as it is stored in the system.

Type needs to be either PDC or Post for post payments, or PMT for payments.

Comment will contain additional information about the payment including the payment method, e.g. Western Union, Check etc.

Reference Number will contain the check number for checks or any relevant number of a payment method.

Rules

The Debt ID must match an existing debt within the system and that account must be active.

If the payment date is in the present or past, but the Type is PDC or Post, then it will be treated as a post payment.

If the payment is a negative amount then it will be stored as a back out and associated with the original payment.

If a payment is received with the same date, the same amount, and the same account as an existing payment within the payment database, then it will not be processed automatically but must be handled manually by client services.

If a back out is received and the account was closed as SIF or PIF, then the account will be opened and the payment posted against it.

This is an example of a comma delimited payment file:

### DEBT ID,PAYMENT DATE,PAYMENT AMOUNT,COLLECTOR,TYPE,COMMENT,REFERENCE NUMBER

### 83923,11/30/2005,6690.82,,PDC, PHONE PAY,9999

### 12883,11/15/2005,−2000,JOE DOE,PMT,CHECK PUR—Paid Us Reversal,21992

### 112324,11/22/2005,1873.2,MIKE WRIGHT,PMT,CHECK PU—Paid Us,43829

b. Recalls

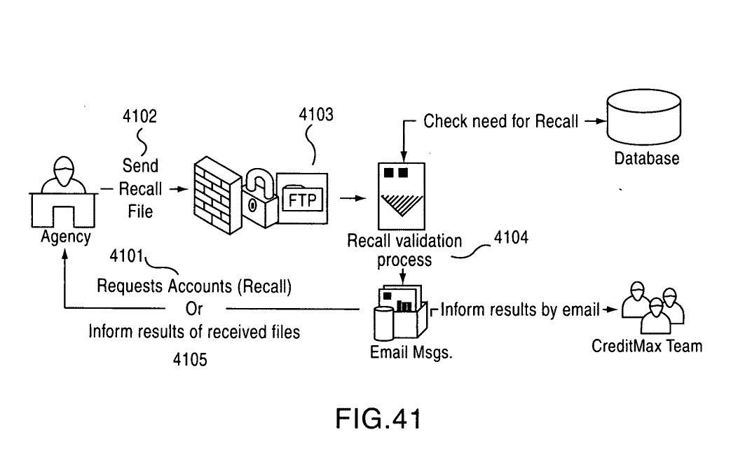

System 100 includes an automated recall process 108b that will automatically begin a process for the return of uncollected debt from collectors after a preset period of time. FIG. 41 is a data flow diagram for an exemplary recall process. For example, system 100 can send an email 4101 requesting the return of accounts for placements at their 120th day of placement. The collectors will send a file 4102 containing the information about the recalled debt to system 100, such as via an FTP site 4103, which can be input into system 100.

Upon receiving the recall file, the automated recall process will validate the file contents 4104. If the file fails any of the validations, then an email 4105 will be sent indicating what the problem(s) were with the file. Using similar logic, if the file is successfully processed; an email 4105 will be sent indicating that the process completed. This process preferably uses a uniform file and procedure to be followed in order to assure correct application of the assignment data. Appendix E of this document to identify the validations.

File Format

The file can be sent in any of three different formats, an excel spreadsheet, a comma-separated values (CSV) text file, or a tab-delimited text file.

The primary columns that are needed are Debt ID, Current Balance, Status, and Keeper Indicator. Personal information should be sent in order to get most updated data. The order of these fields is not important other than the fact that they need to stay consistently the same from your original file.

The process preferably uses a uniform naming convention, file format, and the following procedure must be followed in order to assure correct application of the data. See Appendix F for exceptions.

Debt ID is the unique identifier assigned to the account.

Current Balance is the current balance for the account.

Keeper Indicator is the flag to indicate if agency intends to keep working on the account.

Status is the current status for the account in the agency.

Last Payment Date is the most recent payment date.

Last Payment Amount is the most recent payment amount.

First Name is the debtor's first name.

Last Name is the debtor's last name.

Address 1 is the latest updated Address for the debtor.

Address 2 is the latest updated Address for the debtor.

City is the latest updated City for the debtor.

State is the latest updated State for the debtor.

Zip is the latest updated Zip for the debtor.

Home Phone is the latest updated Home Phone for the debtor.

Work Phone is the latest updated Work Phone for the debtor.

Additional if the new status is:

Bankruptcy then “Additional” will contain the case number.

Cease and Desist then “Additional” will contain “Verbal” or “Written”.

Deceased then “Additional” will contain the date of the death.

Dispute then “Additional” will contain “Verbal” or “Written”.

Attorney Retained then “Additional” will contain the Attorney Name

Additional2 if new status is:

Bankruptcy then “Additional2” will be the date filed.

Attorney Retained then “Additional2” will be the Attorney Phone Number.

Rules

If the account status is Bankruptcy, Cease and Desist, Deceased, Dispute or Attorney Retained then we will need additional information:

Bankruptcy: Case Number and Filed Date

Cease and Desist, Dispute: If it is verbal or written

Deceased: Date of death

Attorney Retained: Name and Phone Number.

c. Reconcile Process

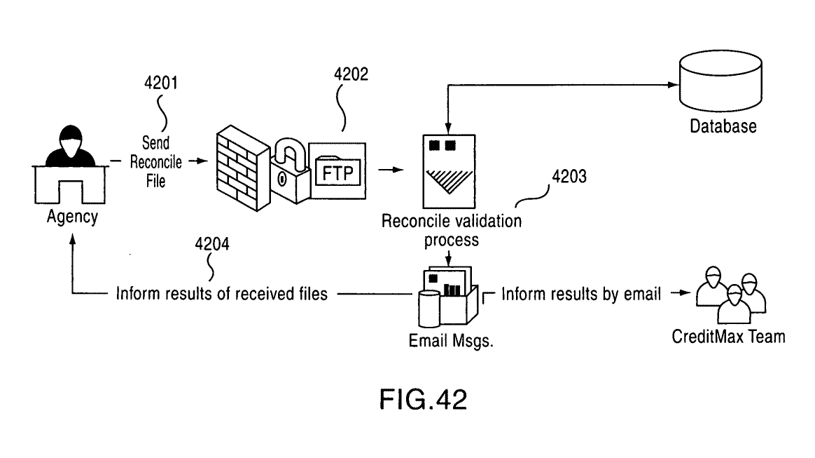

FIG. 42 is a data flow diagram for the reconcile process. Agencies within the network will be required to upload weekly a change in status or information report. The criteria should overlap by one week so that any change in status within the past two weeks should be reported. Addresses and other personal information that changes within two weeks prior should also be reported weekly. The overlap is to ensure that we have reconciled any potential SIF's or PIF's within the file for compliance and regulatory reporting. On a periodic basis a file 4201 should be uploaded to the FTP site 4202 that is formatted as described later in this document. The automated reconcile process 4203 will validate the contents of reconcile files and will send an email 4204 to the agencies if there are any data irregularities. Using similar logic, if the file is successfully processed an email 4204 will be sent indicating that the process completed.

The process preferably uses a uniform naming convention, file format, and the following procedure must be followed in order to assure correct application of the data. See Appendix F for exceptions.

File Name

The file name for the reconcile files should be in the format:

RCNXXXMMDDYY.xls

where RCN represents Reconcile Process, XXX represents the 3 letter agency code, such as AME or FCS, MMDDYY is the 2 digit month (MM), 2 digit day (DD), and the 2 digit year (YY) of the day the file was uploaded.

File Format

The file can be sent in any of three different formats, an excel spreadsheet, a comma-separated values (CSV) text file, or a tab-delimited text file.

The primary columns that we need are Debt ID, Current Balance, and Status. Personal information should be sent in order to get most updated data. The order of these fields is not important other than the fact that they need to stay consistently the same from your original file.

Debt ID is the unique identifier assigned to the account.

Current Balance is the current balance for the account.

Status is the current status for the account in the agency.

Last Payment Date is the most recent payment date.

Last Payment Amount is the most recent payment amount.

First Name is the debtor's first name.

Last Name is the debtor's last name.

Address 1 is the latest updated Address for the debtor.

Address 2 is the latest updated Address for the debtor.

City is the latest updated City for the debtor.

State is the latest updated State for the debtor.

Zip is the latest updated Zip for the debtor.

Home Phone is the latest updated Home Phone for the debtor.

Work Phone is the latest updated Work Phone for the debtor.

Additional if the new status is:

Bankruptcy then “Additional” will contain the case number.

Cease and Desist then “Additional” will contain “Verbal” or “Written”.

Deceased then “Additional” will contain the date of the death.

Dispute then “Additional” will contain “Verbal” or “Written”.

Attorney Retained then “Additional” will contain the Attorney Name

Additional2 if new status is:

Bankruptcy then “Additional2” will be the date filed.

Attorney retained then “Additional2” will be the Attorney Phone Number.

Rules

Accounts in one of the follow statuses can not be updated, and will not be processed manually:

| | |
|---|---|
| 205 | 6 Month Review (INACTIVE) |
| 220 | Bankruptcy 13 Filed |
| 221 | BKY CH7 Filed |
| 251 | Cease & Desist-Written |
| 261 | Verify Deceased |
| 270 | Closed |
| 271 | Closed |
| 272 | Closed |
| 273 | Closed |
| 274 | Closed |
| 275 | Closed |
| 276 | Closed |
| 510 | Closed |
| 520 | Closed |
| 541 | Closed |

New status reported by the agency must be a valid in the records of the system 100.

If new status is B3, B7, Attorney Account, Cease and Desist, Cancelled Dispute or Deceased, agency must send additional information:

Bankruptcy then will be the Case Number and Filed Date.

Cease and Desist then will be “Verbal” or “Written”.

Deceased then will be the date of the death.

Dispute then will be “Verbal” or “Written”.

Attorney Retained then will be the Attorney Name and Phone.

If balance between agency and collections module 108 do not match, then a issue report should be generated.

d. Assignment Process

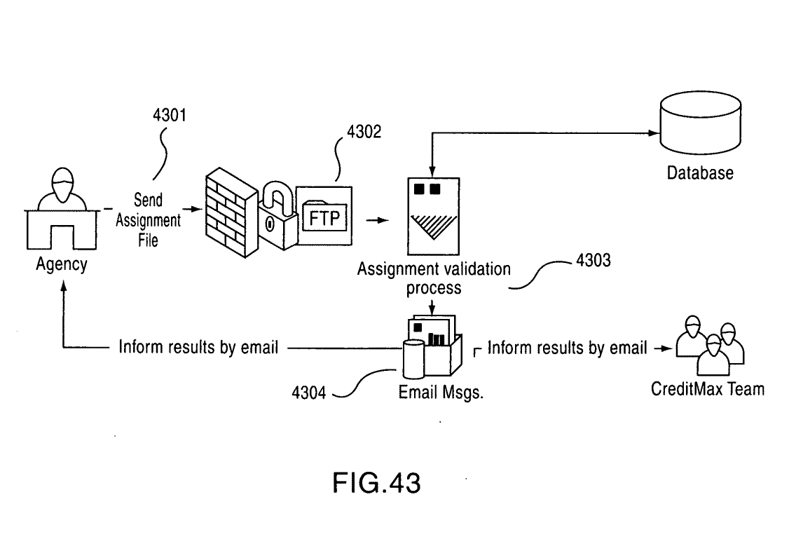

FIG. 43 is a data flow diagram for the assignment process. A Group 60 or Group 120 assignment file 4301 needs to be uploaded immediately after the collectors have been assigned their debt to collect on. This can be uploaded to the same FTP folder 4302 that was assigned to them originally. The system 100 will watch for these files, and validate the data using an assignment validation process 4303 that will check the files to make sure that the collectors and debt ids exist and are properly mapped, then the assignments will be made and a report will be generated. If the file failed any of the validations then an email 4304 will be send indicating what the problem(s) were. If the file was successfully processed an email 4304 will be sent indicating that the process completed.

The process preferably uses a uniform file and procedure to be followed in order to assure correct application of your assignment data document Please see Appendix G of this document to better identify the exceptions.

File Name

The file name for the assignments files should be in the format

ASGXXXMMDDYY-###Day.xls

where ASG represents Account Assignments Process, XXX represents the 3 letter agency code, such as AME or FCS, MMDDYY is the 2 digit month (MM), 2 digit day (DD), and the 2 digit year (YY) of the placement, and ### is either 60 or 120 depending on the period. 60 represents what was formerly called PQ1 and 120 represents what was formerly called PQ2.

File Format

The columns that we are expecting in the assignments file are CMX-ID and Collector Name.

Column 1 is CMX-ID, which is a numeric field that represents the Debt ID as it is assigned.

Column 2 is Collector Name, which is the collector's First Name and Last Name separated by a space.

Rules

The CMX-ID must match an existing debt within the system and it must be associated with the agency sending the assignment.

The Collector Name must match the existing collectors assigned to the agency and if the name does not match and it is not a special designator such as DCD, blank, or a supervisor or owner's name, then it will cause the file to be rejected until the name can be fixed to match exactly the data that is stored in the system.

### Example

| CMX-ID | Collector Name |
|---|---|
| 112233 | JOHN DOE |
| 223344 | JANE DOE |

Intra-Period Assignments

Intra-Period assignments are just like regular assignments but there is an additional field that needs to be populated and there are additional rules. The additional field is a date field indicating when the collector started working on the account.

File Name

The file name for the intra-period assignments files should be in the format

ASGXXXMMDDYY-###IP.xls

where ASG represents Account Assignments Process, XXX represents the 3 letter agency code, such as AME or FCS, MMDDYY is the 2 digit month (MM), 2 digit day (DD), and the 2 digit year (YY) of the placement, and ### is either 60 or 120 depending on the period. 60 represents what was formerly called PQ1 and 120 represents what was formerly called PQ2.

File Format

The columns that are expected in the assignments file are CMX-ID, Collector Name, and Start Date.

Column 1 is CMX-ID, which is a numeric field that represents the Debt ID as it is assigned.

Column 2 is Collector Name, which is the collector's First Name and Last Name separated by a space.

Column 3 is Start Date, which is the date that the collector was assigned the account.

Rules

The CMX-ID must match an existing debt within the CreditMax system and it must be associated with the agency sending the assignment.

The Collector Name must match the existing collectors assigned to the agency and if the name does not match and it is not a special designator such as DCD, blank, or a supervisor or owner's name, then it will cause the file to be rejected until the name can be fixed to match exactly the data that is stored in our systems.

Per Placement, the sum of the UPB for the accounts that the collector is receiving cannot exceed 20% of the sum of the UPB already assigned to the collector.

Reassignments will not be accepted within 10 days of the end of a period.

If a reassignment for a collector is in a period other than the period indicated by the file, then the assignment will be invalid and the file will be rejected.

### Example

| CMX-ID | Collector Name | Start Date |
|---|---|---|
| 112233 | JANE DOE | Nov, 1, 2005 |
| 223344 | JIMMY DOE | Nov, 1, 2005 |

e. Agency/Collector Portal

The agency/collector portal provides agencies and collectors access to system 100 for the purpose of entering information (e.g., survey, favorites, etc.), updating information, viewing account information and historical data, etc. Accordingly, the portal can include forms, web pages (e.g., Java, HTML, etc.), or the like, which can provide access over an electronic data network, such as the Internet. Further, appropriate security, such as password protection, may be used to secure the system 100. Such forms, web pages, security, etc. are well known.

Forms or pages should be provided for several different kinds of users. For example, agency supervisors will want screens that display comprehensive reports on how well the agency is performing, how each collector is performing relative to his or her peers, how payments are being made, etc. Individual collectors will want to review their own portfolios, targets, etc. See, for example, FIG. 18. Further, collectors will need to be able to update their own personal information. Also, forms should be provided for performing collector or agency functions, such as for taking the psychological survey.

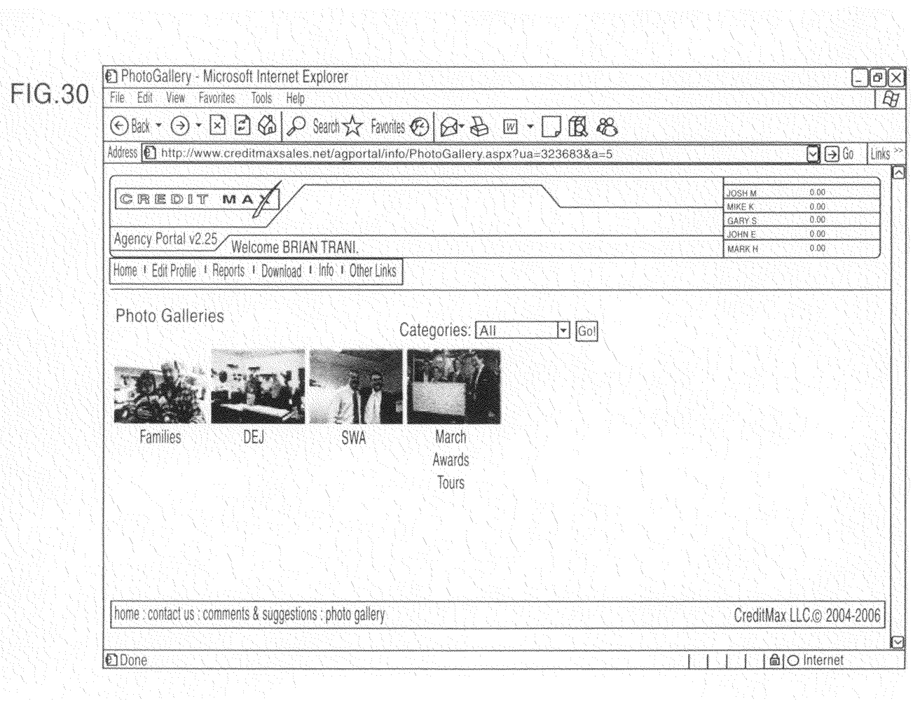

FIGS. 23-39 are exemplary screen shots of web portal pages. The contents of each screen shot is self evident. FIG. 30 allows users to view photographs.

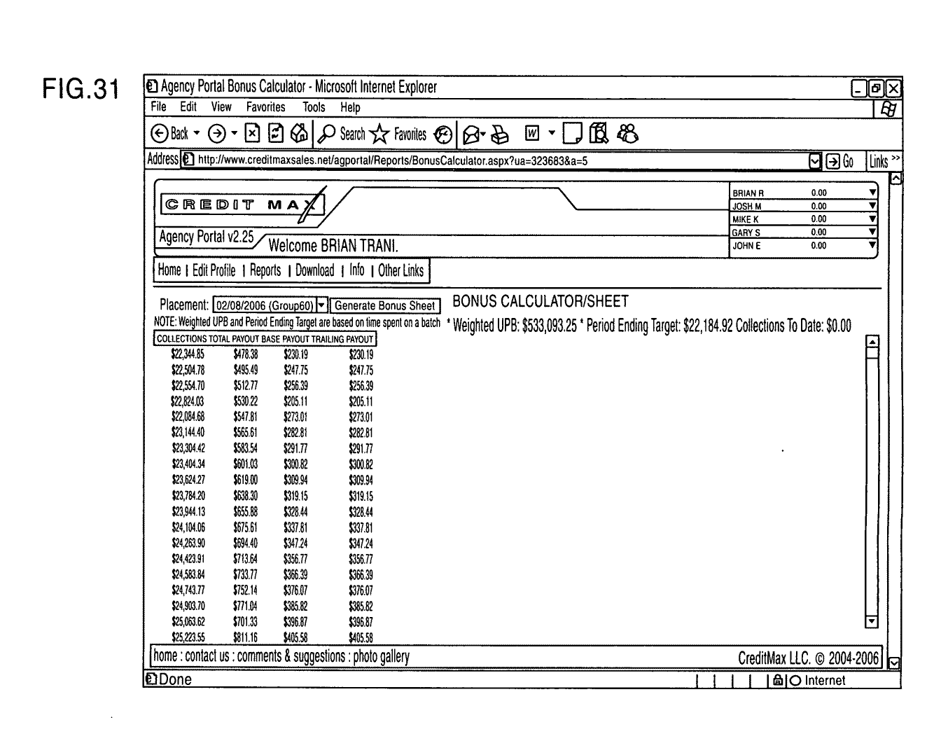

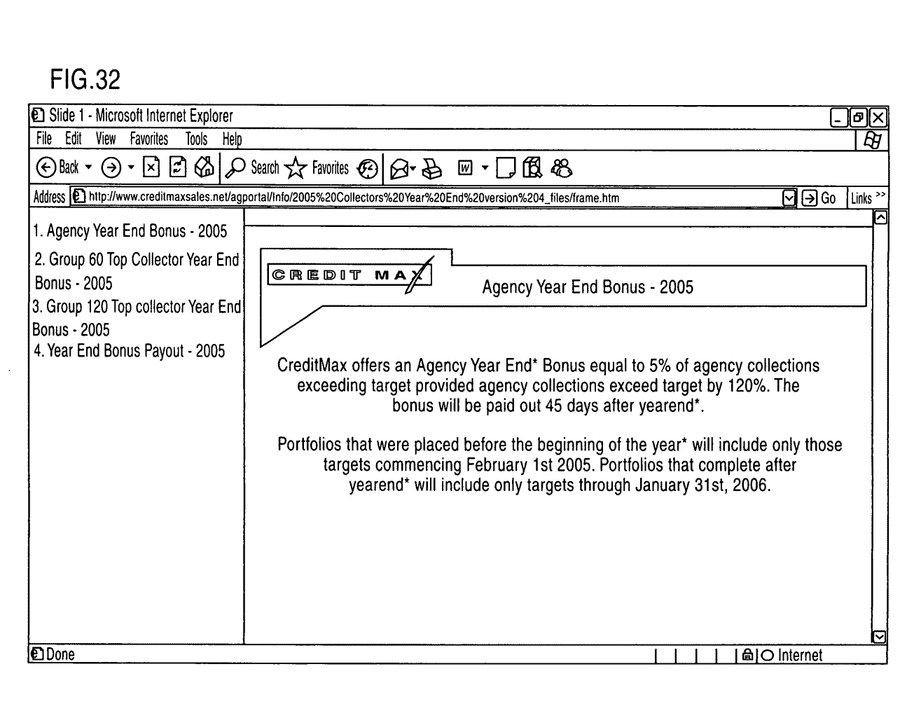

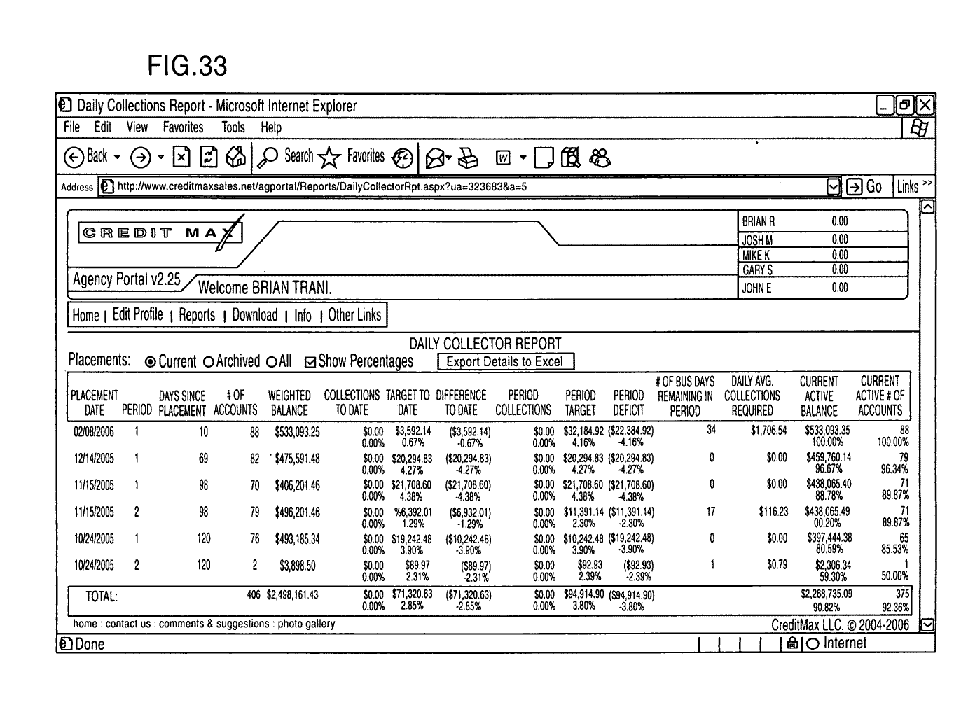

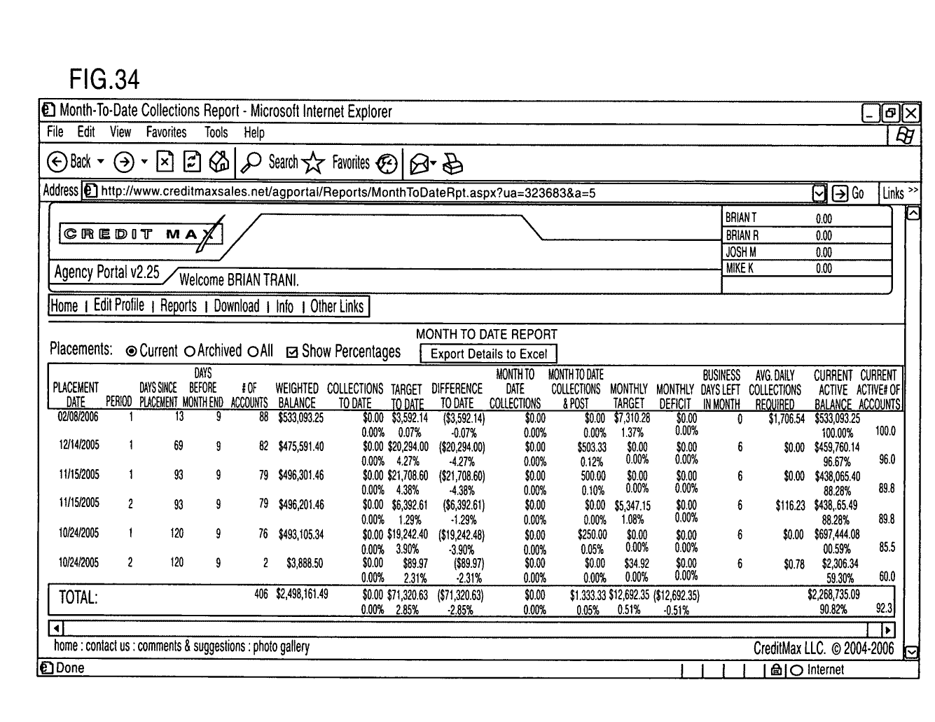

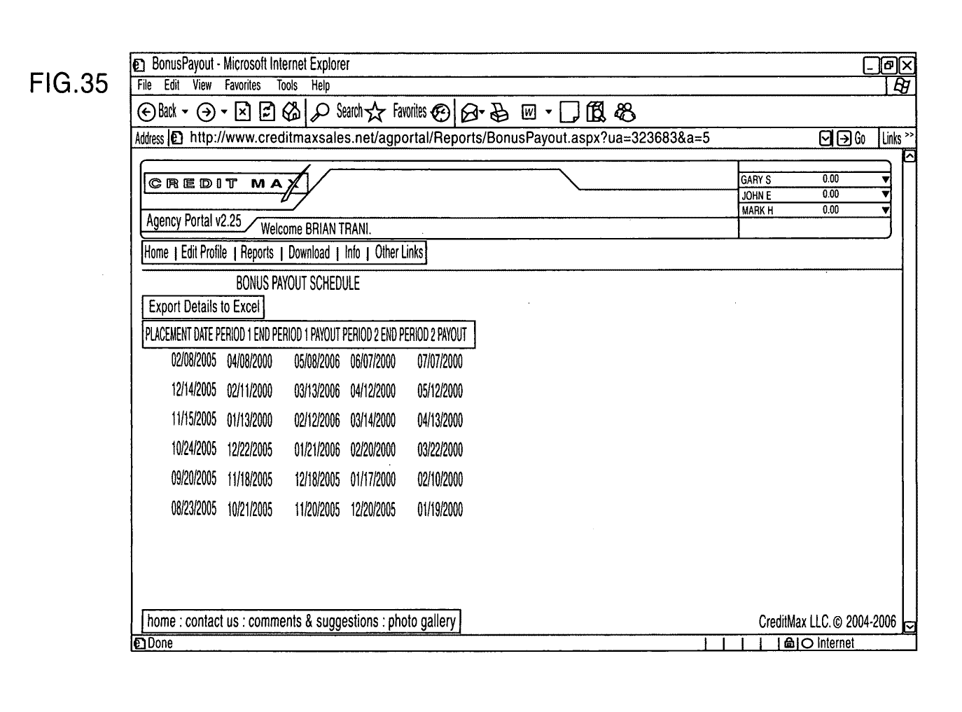

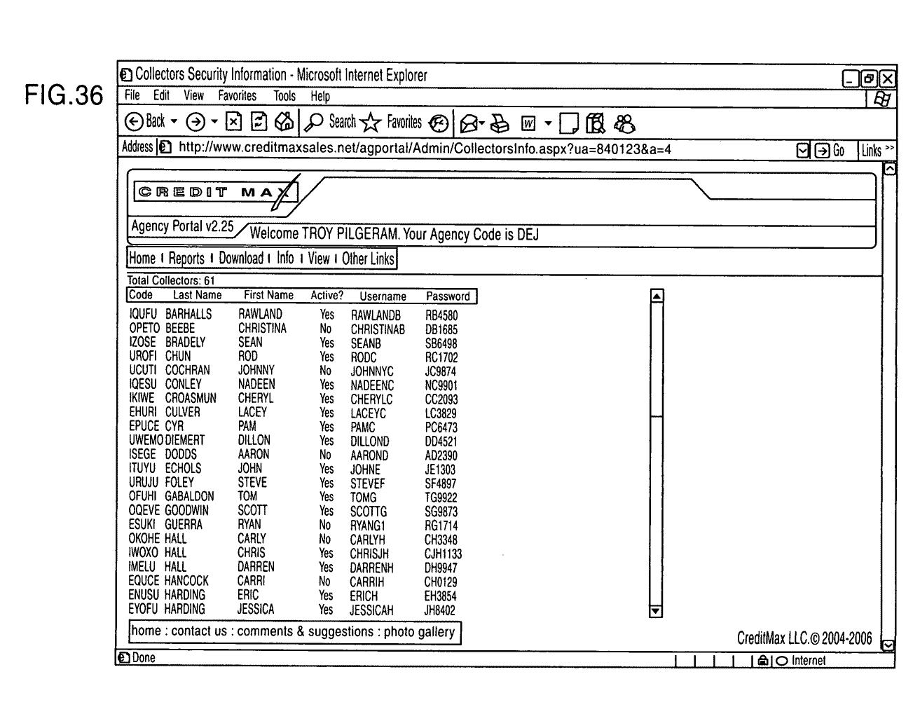

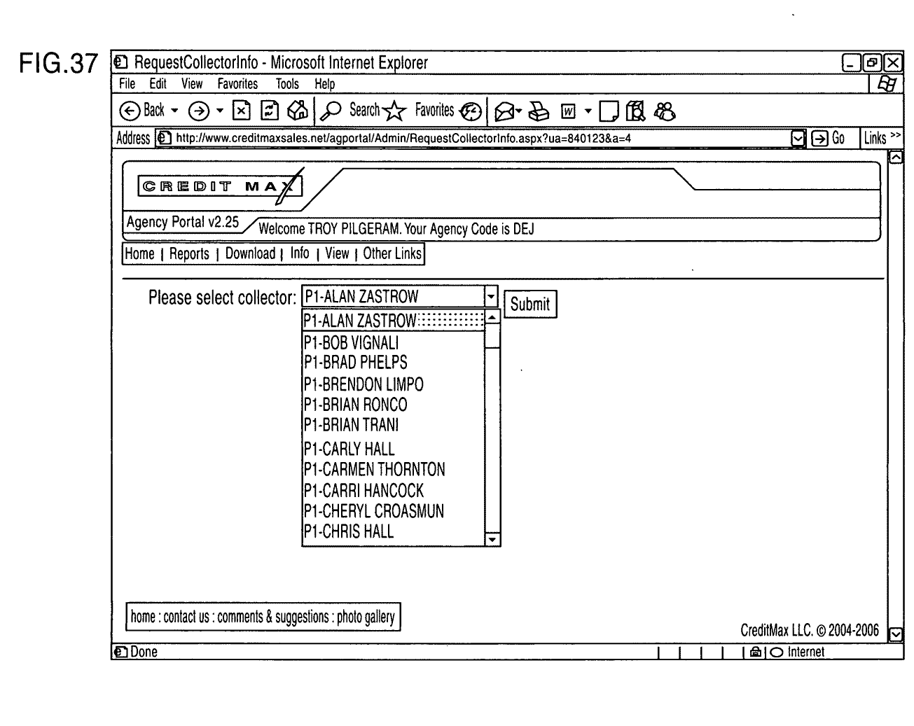

FIG. 31 allows a user to view a bonus calculator, which shows the payout for collections. FIG. 32 is the year end bonus page and describes the year end bonus for groups of collectors. FIG. 33 is the daily collector report, which shows the status of debt portfolios including performance against set goals. FIG. 34 is the month to date report, which shows the status of debt accounts on a monthly basis. FIG. 35 shows a bonus payout schedule. FIGS. 36-37 are exemplary administrative forms.

f. Selection Process and Placement Model

According to one aspect of the present invention, system 100 is configured to parse debt portfolios and to select and place debt with the creditor that is most ideal for the debt, based on information stored about the debt and about each collector. For example, some collectors may be better suited for collecting small debts from elderly women while others are better collecting large debts from middle aged men. Other things may be considered in matching a collector with debt, such as geography and ethnicity. The means for placing debt with creditors is preferably flexible in nature and should allow debt to be placed with agencies in customized portfolios. For example, accounts in Texas can be packaged and placed with agencies in Texas, rather than say, Montana.

In one embodiment, the selection and placement of debt are performed by the selection process 802f and placement module 802g of the collections system 108 according to a debt placement distribution plan. The selection process 102f and placement module 102g can access and receive data from AMS 102, including historical collections data, debt portfolio data, and collector survey and profile data. Complex algorithms can be executed in order to match debt with the collector(s) that will most likely be able to collect on the debt. By placing debt with a corresponding ideal collector, the efficiency of the entire debt collection can be increased dramatically.

i. Collector Selection Process

The collector selection process identifies similar characteristics with existing collectors to a) group them and b) correlate with the liquidation of existing collectors to identify “top collector” profiles. The process also determines where new collectors groups similar to a) thus identifying if they are b) “top collector.”

ii. Placement Model

In the placement model, collectors' historical data are analyzed to determine their liquidation (collections/original balance) in a) regions (e.g., each state), b) balance groups (e.g., 0-500 original balance, 501-1000 original balance, etc.) and c) each day since the last payment group (e.g., 0-180 days since last payment, 180-365 days since last payment, etc.). Then, the average liquidation for a) each region, b) each balance group, and c) each days since last payment is calculated (collections/original balance). The accounts are preferably assigned to collectors that are above average in each category a, b and c, by comparing the collectors that are the highest above average in any group of a, b and c, and that have the greatest difference above other collectors in that group.

g. Alert Management Interface

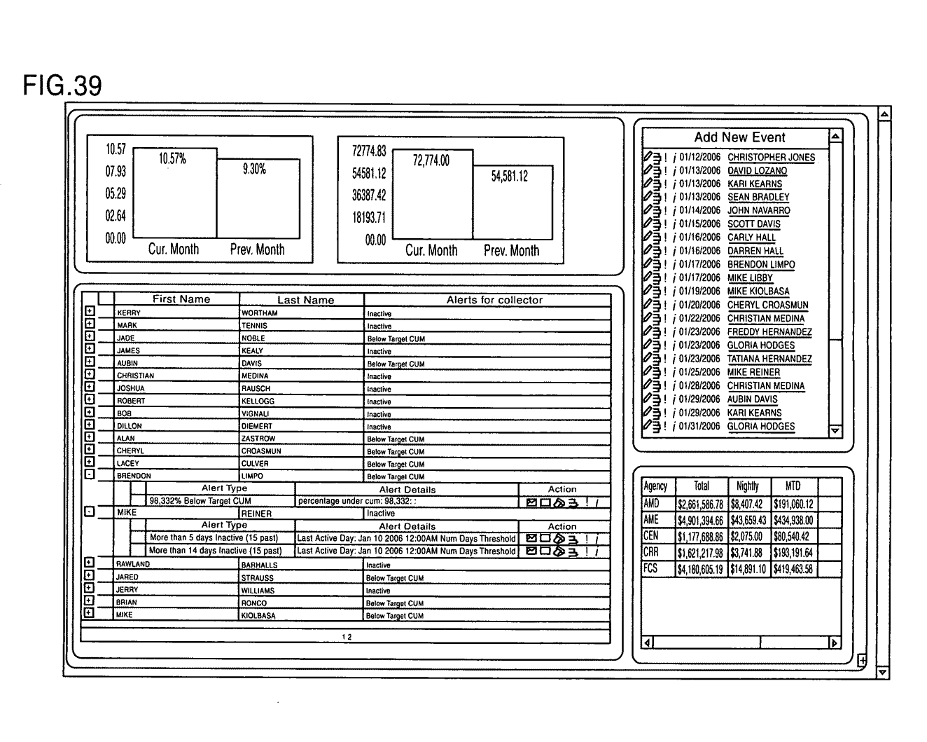

The alert management interface 108i consolidates important information for quick, convenient access. FIG. 39 is a screen shot of an exemplary alert management interface page. In the top left, graphs show a snapshot view of present activity versus previous activity to determine trending up or down. In the top right, events are displayed, such as collectors' birthdays and anniversaries, and provides a means to quickly access collectors' “favorites” for gifts. In the bottom left, alerts are displayed for each collector. The alerts identify significant events in collector's collection activities, both positive and negative, and provide multiple means of contacting collectors, either automatically based on business rules or manually at a manager's discretion, and notating contact. In the bottom right are reports. These reports preferably identify key figures necessary to evaluate and communicate progress with collectors and agencies.

Exemplary alerts may includes an alert for a collector that has gone 5 days without a payment or postdated check activity or 14 days without a payment or postdated check activity, or if a number of collections, such as 4 collections, were significantly below (e.g., 20%) target accumulation.

The alert management interface 108i can be configured to generate messages upon the existence of an alert. These messages may be, for example, email messages, portal messages, letters, collector portal web marquees, etc. The messages can notify the collectors of the alert or the assignor of the debt. The alert management interface 108i can also generate telephone calls or schedule a callback for another day. Events and favorites can also be emailed to an incentive and bonus program specialist.

### 5. Incentive and Bonus Program

The collections system 108 includes an incentive and bonus module 108h, which implements an incentive and bonus program for collectors and collection agency that are part of the network. The incentive and bonus module include motivational tools to incentivize collectors. The incentive and bonus program module 108h is configured to automatically identify targets or goals, and collectors or agencies will be rewarded bonuses by exceeding their targets. An algorithm can be provided for calculating targets. Further, bonus curves can be used.

A target algorithm a) identifies accounts placed in a specific portfolio, b) calculates liquidation per state in previous portfolios {x}, then c) calculates percentage of portfolio that each state represents {y}, then d) determines the expected liquidation that a state would represent of a portfolio {x}*{y}={z}, then e) determines the percentile of that states represented liquidation {z} of the total {z}/sum({z})={a}, and then f) multiplies {a} against the expected target for 120 days supplied by management (0.054) to determine the factor for multiplying against the original balance.

Once targets have been determined on a portfolio, then a bonus payout is available for collections above the target on a portfolio. As an example, if the target for 16 accounts (100,000 original balance) that a collector is working is 3000, then if the collector collects 4000, the collector can make a bonus of 24.

Bonus schedules are provided as the calculations of the previous example, in increments above target. For example, if the target is 3000, then the first line of a bonus schedule would be 3013 with a payout of 2, the next line would be 3026 with a payout of 4, and the next line would be 3039 with a payout of 6. That is, the schedule can be the exact calculation of the payout as a polynomial equation, which may be modified regularly. One example polynomial is 7.4(x)⁴+1.09(x)³+0.03(x)²+0.07(x)+0.088, where x is the collections.

Targets may be adjusted up or down, by for example, the agency supervisor or secondary issuers, in order to take into account individual performance. For example, it might be desired to raise the targets for superior collectors.

Also, other factors may be considered in the calculation of targets, such as seasonality, debt size or other variables.

The incentive program also includes functions for issuing awards, such as birthday and anniversary gifts, awards for loyalty or performance, etc. Accordingly, the collector profile information can be used to tailor such awards. For example, “favorites” information can be used to generate an award for a collector that is more thoughtful, such as a gift certificate to their favorite restaurant or tickets to see their favorite sports team compete. This combination of awards and bonuses greatly improves performance and loyalty of collectors.

Games are also part of the incentive and bonus program. For example, collectors are matched with each other in a tournament (e.g., like the NCAA basket ball tournament), the winner of which gets a prize. For example, in the top right corner of FIG. 9 is a view of the tournament results.

Thus, a number of preferred embodiments have been fully described above with reference to the drawing figures. Although the invention has been described based upon these preferred embodiments, it would be apparent to those of skill in the art that certain modifications, variations, and alternative constructions could be made to the described embodiments within the spirit and scope of the invention.

One having ordinary skill in the art should understand that the above described system and method may be implemented a number of ways. Further, appropriate graphical user interfaces, security, and encryption may be incorporated as appropriate. For example, one should understand that the operator of the system (the assignor of debt and debt reseller) should have a desire to provide secure access to collectors for some forms and not others. Therefore, a tiered security structure might be implemented. As another example, rather than exchanging information via an FTP site, a separate portal might be providing for importing account files.

1. A system for comprehensive debt management, comprising:
means for maintaining data relating to acquired debt;
means for analyzing said acquired debt data and assigning portions of said acquired debt to collection agencies;
means for accounting collection payments from said collection agencies relating to said assigned portions of debt;
means for recalling uncollected portions of said assigned portions of debt from the agencies; and
means for selling the recalled debt.

2. The system as recited in claim 1, further comprising:
portal means for allowing said collection agencies to display data relating to the portion of debt assigned thereto.

3. The system as recited in claim 1, wherein:
said means for analyzing said acquired debt data assigns portions of debt based upon matching attributes of said portion with attributes of said assigned collection agency.

4. The system as recited in claim 3, wherein:
said means for analyzing said acquired debt data identifies portions of debt having common demographic characteristics and assigns said portions to collection agencies based upon said demographic characteristics.

5. The system as recited in claim 1, wherein:
said acquired debt is acquired in debt portfolios from a primary issuer of said debt and comprises past due credit card accounts.

6. The system as recited in claim 5, wherein:
said debt portfolios covering geographical areas and said means for analyzing said acquired debt data parses said debt portfolios to generate said portions.

7. The system as recited in claim 1, wherein:
said means for recalling uncollected portions of said assigned portions of debt from the agencies recalls uncollected portions of debt after a predetermined period of time expires after the debt was assigned to the collection agency.

8. The system as recited in claim 7, wherein:
said predetermined period of time is 120 days.

9. The system as recited in claim 1, wherein:
said means for analyzing said acquired debt data assigns said portions to collection agencies that have a highest probability of collecting said portion of debt based on historical collection data relating to said collection agency.

10. The system as recited in claim 7, wherein:
said means for recalling uncollected portions of said assigned portions of debt from the agencies recalls uncollected portions of debt automatically.

11. The system as recited in claim 10, wherein:
said means for recalling uncollected portions of said assigned portions of debt automatically recalls said uncollected portions by automatically generating an electronic mail to said agency identifying the debt to be returned.

12. The system as recited in claim 1, wherein: said means for selling the recalled debt includes a web portal interface that allows a user to search for and purchase debt portfolios online.

13. The system as recited in claim 12, wherein: said means for selling the recalled debt includes a web portal interface that allows a user to create custom debt portfolios from available debt portfolios.

14. The system as recited in claim 12, wherein: said means for selling the recalled debt includes a web portal interface that allows a user to purchase individual debt accounts.

15. The system as recited in claim 1, further comprising an incentive and bonus program module that maintains profile data relating to each individual collector for each of said collection agencies and automatically generates incentive awards.
